(19) United States
(12) Patent Application Publication
(10) Pub. No.: US 2011/0011678 A1
(43) Pub. Date: Jan. 20, 2011

(54) Ladder stabilisation and safety system

(76) Inventor: Lance Rodney Sheffield, Sevenoaks (GB)

Correspondence Address: Guy McClung, P O Box 2553, Rockport, TX, 78381-2553, US

(21) Appl. No.: 12/736,283

(22) PCT Filed: Mar. 26, 2009
(86) PCT No.: PCT/GB2009/050294

§ 371 Date: Sep. 25, 2010

(30) Foreign Application Priority Data
Mar. 27, 2008 (GB) 0805568.3

(51) Int. Cl. G05G 5/06; F16M 11/26; E06C 7/06; E04G 1/22; E06C 1/22; E06C 1/12; B23P 11/00

(52) U.S. Cl. 182/141; 74/535; 248/188.5; 182/209; 182/172; 29/428

(57) ABSTRACT

Expandable load bearing device for use on a ladder and comprising an outer member (20), an inner member (21) movable within the outer member, and ratchet means having a pawl (26) attachable to the outer member and a rack (22) attachable to the inner member, the pawl being movable into and out of engagement with the rack to prevent the movement of the inner member towards the outer member, and the pawl having a shoulder (36d) arranged to bear upon a load transfer member (24) on the outer member when the pawl is in engagement with the rack.

### FIELD OF THE INVENTION

This Patent Specification relates to a stability (stabilisation) and safety system that can be incorporating a to wide range of ladders, step ladders and access equipment and in concern to make the equipment far safer and easier to use than previously possible.

### BACKGROUND OF THE INVENTION

Ladder levelling and stabilising equipments available on the market at present are generally add on devices that are stored or transported separately from the ladder and thus require additional operations to collect and set them up for use. This takes time and is liable to be neglected. Often a ladder user will think the ladder safe, use it without the safety equipment and then have an accident, resulting in serious injury or even death.

Certain manufacturers are at last providing equipment attached to ladders; these include stabiliser bars between the two stiles at ground level extending sideways, levelling devices almost along the same lines with other manufacturers having stabiliser legs fitted. The problems with all these devices are that solutions in one plane cause problems in others. There is no stability and safety equipment that can cover all the ways ladders are now being used and that will allow simple storage and transportation.

European Patent Specification 1032747 describes a ladder levelling device comprising: a ladder extender attachable to a ladder stile; ratchet means for preventing the extender from retracting, the ratchet means having a first rack fixed to the stile and a second rack attached to the extender and engageable with the first rack; and disengagement means operable to disengage the second rack from the first rack and permit the extender to retract with respect to the ladder.

The first major aspect of the present inventions represents a considerable improvement over the disclosure of this earlier patent. It relates to a telescopic load-bearing device that is simpler, more compact and can accept wide loading capability within cross sections similar to the ladder stiles. It can be used for extending stabiliser legs so enabling an item having a plurality of legs to be placed evenly upon an uneven or sloping surface. It is particularly concerned with stabilisation of a ladder, a step ladder and an access tower, though also suitable for use with such devices as tripods, easels and tables.

European Patent Specification 1711678 describes ladder stabilisation means wherein stabiliser legs are attached one to each stile of a ladder and arranged to be swung outwardly and rearwardly from the ladder and to be lockable in stowed and deployed configurations.

A second aspect of the present invention provides improved stabilising systems. The present invention accordingly provides improvements in the ladder stabilisation equipment as described in European Patent Specifications 1032747 and 1711678. In combination the first and second aspects provide equipment that can make the use of a standard type extension ladder far safer as well as making it easier to set up even on sloping or uneven ground. The devices according to the invention can be permanently attached to the ladder etc and so would be always available for use, giving the ladder four feet on the ground in only about ten seconds. The ladder can be arranged not to topple or slip sideways even when the top was unsecured; the base would not slip back even when a shallower ladder slope was employed. The stabilising leg arrangement and can be arranged to provide stability to the ladder when used in the vertical plane as with access towers.

Whilst permanently attached the stabilisers and levellers and very preferably arranged to close up in such a way when not in use as to minimise obstructions and projection from the simple lines of existing extending ladders, and be so secured as to aid rather than hinder ladder storage and transportation. That preference extends to every component including any fitted flexible straps and ties.

Ladders are mass produced and can therefore be relatively inexpensive. It is thus particularly important for any accessory to come at a price which is proportionate to the price of a ladder. However, because any ladder stabilising device will require to be strong, to have a long life, and to be substantially incapable of failure, the cost thereof risks being wholly disproportionate to that of the ladder. No moving device will ever last as long as a plain aluminium ladder, other materials suffer deterioration and corrosion besides actual wear due to the movement so easy means of replacement is highly desirable.

The number of ladder types already in existence is huge. Aluminium ladders have been produced for over fifty years and there are other types and construction materials. Thus it is a feature of the present invention that it is available to improve the safety of a large proportion of existing stock as well as new ladders. Ladders now manufactured extend basic ladder utilisation from simply lean-to usage to two and three part extension ladders that now fold to form composite ladders which operate work like very tall step ladders. Many indeed can be erected as lightweight access towers.

### SUMMARY OF THE PRESENT INVENTION

The present invention is a ladder stabilising and safety system which brings together a number of inventive steps some of which have other applications beyond pure attachment to ladders, steps etc.

The basic aspects of the present invention are as follows:
1. An expandable or telescopic load bearing device:
   a. Used within levelling equipment by extending ladder stiles;
   b. Used within stabiliser legs to extend same to the ground;
   c. Other uses with tables, tripods etc.
2. Stabiliser hub and leg arrangements to achieve:
   a. Double operating positions for legs;
   b. Effective stowed configuration for legs;
   c. Accommodation of ladder deflections during usage.
3. Foldable stabiliser tie or strap system to accommodate:
   a. Two different operating and a stowed position;
   b. Additional ties to compensate for great variation in leg lengths.
4. Detachable stabiliser device for use with steps, composites access towers.
5. Simplified step ladder anti-wobble/levelling device
6. Load transfer fixing between devices and a range of ladders.
7. Jointing system for hollow and other section ladder stiles.
8. A clearly visible safe/unsafe ladder slope warning indicator.
9. A safe/unsafe stile stabiliser extension indicator.
10. The development of low friction bearing element between sliding components.

Each section will be taken in the above order though there will be cross references for the purposes of clarity.

First or Major Core Element—Telescopic Load Bearing Device

The first and major core element of the ladder stabilising system comprises a telescopic load-bearing mechanism that will transmit forces in an efficient and cost effective manner between members of an expandable load bearing device. This may be used on ladders, step ladders and other access equipment and stabiliser legs attached to any of these as well as to other equipment such as easels, tripods and tables.

Load Bearing Shoulder

According to a first aspect of the invention an expandable or telescopic load bearing device comprises: an outer member, an inner member longitudinally movable within the outer member; and ratchet means having a pawl attachable to the outer member and a rack attachable to the inner member, the pawl being movable into and out of engagement with the rack to control expansion and retraction of the inner member within the outer member, and the pawl having a shoulder arranged to bear upon a load transfer face fitted to the outer member when the pawl is in engagement with the rack.

It will be appreciated that the term “outer” implies that the outer member is substantially tubular, where “tubular” defines a structure which holds the inner member without being necessarily fully tubular either in the peripheral or lengthwise senses.

Pivot Pin & Plastic Pawl

Whilst the simplest arrangement for engaging and disengaging the pawl is a pivot pin, the function of this first aspect of the invention is to ensure that the compressive force transmitted from the inner member via the ratchet means to the outer member, is not substantially borne by the pivot pin but by a shoulder and load transfer means. This may be assisted by slight ovality or irregularity of the pivot pin in relation to the bearing surface in which the pin rotates. During load bearing the pivot pin only holds the ratchet means in the horizontal plane thus preventing leverage forces developing on the pin which might have a tendency to disengage the ratchet teeth. Wear on the pin can be substantially attenuated and a relatively inexpensive material, and production method thereof, can be employed in the ratchet means. As load taken by the pivot is reduced the housing or holding component connecting the pawl device to the outer member may also be of moulded plastic.

Wear can also be reduced between the rack and the pawl. To this end the pawl advantageously has several rack engaging teeth. Additionally the rack and the pawl may be moulded in a plastics material such as nylon and polycarbonate with other materials such as PTFE to reduce friction between these ratchet elements.

Pawl Carrier & Protrusion

The pawl together with its carrier, the shoulder, the pivot and an operation member may accordingly be constructed together as one moulded plastic component, with the shoulder being substantially adjacent the pivot together with a protrusion which augments the fitment of the pawl carrier to the outer member, preferably by engaging around a load transfer element attached to the outer member. This protrusion may also be arranged to act as a brake by bearing against the rack when the operation member is depressed or, depending upon the arrangement and operation of the assembly this protrusion can be arranged to prevent removal of the inner member from the assembly. Spring means may also be provided to urge the pawl into engagement with the rack.

Load Bearing—Ratchet Size

This first aspect of the invention has wide and important further advantages. With metal elements almost completely removed corrosion due to electrolytic action can be minimised. Load bearing ladder levelling devices can be manufactured at reasonable costs, can readily be installed within hollow stiles or be simply attached to the sides of stiles. While ladder stile widths vary in line with overall ladder length because of the increased bending and deflection forces, the width of the ratchet and pawl elements need not completely match stile width, but can be based upon ladder load rating. This can keep down tooling and manufacturing costs.

Size of Load Transfer

The load transfer element can be an extruded aluminium section inserted through a perforation, forming a rectangular aperture or slot in the side wall of the outer member and clipping between the inner and outer faces over the wall thickness thereby effectively increasing the thickness of the outer wall at the load bearing point of contact between the pawl and the outer member. The construction also allows the rack and pawl width to occupy a large proportion of the width of the device. This accordingly allows the load transfer means to have as large an area as possible to transfer the loads between the inner and outer members.

Pawl Protection & Locking Device

In a simple arrangement of the first aspect of invention, a shield may be fitted to the first member to reduce the possibility of accidental disengagement of the pawl from the rack, for example by depression of the operation member, even though the engagement of the pawl and the rack may be maintained by spring means.

Depending upon the performance requirements of the assembly a positive locking device may be provided. Besides locking movement of the pawl assembly the locking device can be arranged to cause the transmission of load forces laterally to augment resistance to movement by friction between the inner and outer members. Also the rack and pawl teeth may be angled slightly so that they tend to cause positive engagement. This option can ensure that the load on the element is removed before being able to release the ratchet. Preferably the locking device is colour coded, for example in red, to indicate when it is not operational.

Spring Return

Spring means may be provided acting between the outer and inner members and urging retraction of the one into the other or expansion of the two members. These spring means may be provided by coil springs or elastomeric material depending upon expansion required relative to the overall length of the assembly. The spring means may also serve to assist in retaining the inner member within the outer. However a projecting part of the pawl may be arranged to engage with a protrusion of the rack in the outer member for this purpose. In a preferred embodiment the spring means comprises a fabric coated elastic which may be attached or wedged to the base of the inner member. Where the inner member has a cross section comprising a central rack supporting recess and two side lobes, the spring means conveniently passes along the side lobes.

Inner Member Side Lobes

The inner member may be an extrusion formed with a rack location groove thereon and a pair of side lobes. Indeed, this may be the form of the inner member in general particularly, as will be described, when the side lobes accommodate a spring return facility.

Reduce Wear & Friction

To reduce wear between an inner member and an outer, and perhaps to reduce the possibility of fusion between the two, either the inner member or the outer may carry friction reduction means. A particularly suitable arrangement where the inner member comprises a metal extrusion is for the extrusion to be formed with appropriately sited grooves adopted to receive a strip of a low friction plastics material such as nylon or PTFE. The grooves may be formed with retention means such as a rebate or lips, the compression and deformation of the plastics material may be enough to hold it in place in a parallel sided groove, but insertion pressure will force plastic sections through a restrictive space and on release of pressure the material will expand locking it in position.

Fitment of the bearing material may be achieved in an extrusion process. This arrangement may have uses beyond that of incorporation into a levelling device according to the invention. This element of the stabiliser system is considered later.

Foot of Extended Device

A base portion to the inner member may carry a foot pedal whereby the inner member may be extended relative to the outer member simply by the user pushing down with his foot thereon. The said base portion may comprise a base adapted to bear upon a surface such as the ground. This base may be integral with the foot pedal. With mechanisms extending to reach uneven or sloping ground the relative angle between the two elements is likely to vary. To accommodate these variations with stabilisers an angled foot can be simply rotated in a plane square to the leg or a ball and socket arrangement may be provided.

Fixing Space Above Pawl

A valuable element of the telescopic load bearing device can be that the space above the pawl and pawl housing within the outer member is during all operations of the extending mechanism, capable of being clear of any part of the inner member. This allows fixings to be attached to the outer member above the pawl housing.

Second Core Element—1^{st} Used as Levelling Device

Use on a Ladder

It will be appreciated that the expression “for use on a ladder” does not in any way limit the device to use on a ladder, and the present specification provides examples of other uses. It will also be appreciated that where, in this patent specification the expression “levelling device” occurs in relation to a ladder, it refers to a need for the rungs of an erected ladder to be substantially level.

Pawl to Hollow Stile Ladder as Levelling Device

According to a further feature of the first aspect of the invention the pawl may be mounted on a pawl carrier whereby the pawl and pawl carrier can be fitted or perhaps retrofitted, to a ladder or other form of access equipment etc as a pawl unit. In this context, if the ladder stile is hollow it may provide the outer member, and a ladder foot extender, inside the ladder stile, the inner member.

Preferably therefore the rack is attached to the ladder foot extender and the pawl is movably attached to the ladder stile. Generally a levelling device in accordance with the invention will be fitted to the lower end of both stiles of the ladder. It will be appreciated that where the ladder stile is hollow, an internal device is likely only to extend between the foot of the ladder and the first rung thereof. It may be preferred for the pawl to have an arm projecting outwardly of the ladder for ease of operation. Alternatively, projecting inwardly, below the first rung, is fairly unobtrusive and means that ladder storage is not inconvenienced.

Moreover it is also possible to provide a ladder where only one stile incorporates a levelling device in accordance with the invention. The pawl set in a hollow stile automatically limits the extension capability of the inner member of a levelling device so fitted. In general use this is quite acceptable, but throughout the country there are areas where ground slopes cause problems. Even in flat areas steps and garden spaces can compound the problems, so there should ideally be ways of effectively extending a stiles length downwards, but this needs to be quick, easy to fix and remove when not required and be safe, and be still adjustable by incremental amounts over limited ranges.

There are a number of ways in which this can be achieved. Present ladders require certain strengths of the end cantilever sections of the stiles beyond the first or last rungs. By considering the forces at 90 degrees to the main bending resistance of the stile the smaller dimension of the stile is arrived at. It is typically around 25 mm. Any extension of the stiles increases the cantilever forces so should be restricted to a predetermined amount. Only one leveller should be used at any time and the other should be fully retracted. Having one stile at the minimum length reduces the cantilever forces as the ladder works as a structure with the shorter element providing the necessary side restraint.

To extend the levelling capability of a hollow stile ladder with a pawl fitted, there may be provided an extension component in the form of a ‘C’ shaped extrusion which fits around the stile and over the rung lug with a rubber foot component at the lower end and a series of holes through which to pass a bolt which locks the extension component to a fixing mechanism within the rung. The extension component allows extension of one stile with the levelling mechanism on that stile being inoperative while the incremental adjustment is taken over by the levelling device in the other stile. To accommodate a reverse slope all that is needed is to detach extension component and fix it to the other stile. Where the rungs are not along the centreline of a stile there can be a double row of holes to allow the interchange between stiles.

Pawl to ‘C’ or ‘I’ Section, Solid and Other Ladders

Where the ladder stile comprises only a front and rear face and one side wall, that is it has a ‘C’ or ‘I’ section, is solid or is a side add-on to any ladder or steps, the device may extend up the stile further than the first rung. This gives greater extension capability, though within the stabiliser system the top of the levelling device is preferably kept below the second rung.

For fitting to ‘C’ or ‘I’ section stiles the outer member may be extruded so that it fits and slides within the stiles. The extension capability of a standard version can be the same as with hollow stiles, but having the extrusion longer up to rung two it is possible to have three positions in which it can be mounted with respect to the stiles. Vertical positioning is achieved with an anchorage bolt which locks the extension component to the fixing mechanism within the first rung. Being locked solid with respect to the ladder stile it is possible to have longer levelling units with greater expansion capability, but when fully retracted the foot is likely to be lower than a standard type ladder without any device fitted. To return to general use the longer extenders can be replaced with the standard version. With the core mechanical fixing element this operation will take only a minute or so.

With general ladder use the above extended levelling capability can be little used except when positioned on steps and stairways, where the difference in levels can be around 250 mm maximum. Constructing a lightweight access tower is completely different as the site may slope or be obstructed by low walls and banks of earth etc. adjacent the building being accessed. Many mobile scaffold type access towers need relatively level bases. The present invention stands to overcome the problem.

Ladder Access Towers

The capability of adding fixed or variable length stile extensions that can be easily attached in a range of positions allows stiles to be extended to the desired length. This can allow ladders to be used as a lightweight access tower square to the line of the ground slope even to accommodate dwarf walls etc.

The most flexible solutions seem to be based upon the concept of a levelling device having small incremental changes in length adaptable over a limited range coupled with a holding element that is manually adjustable to larger incremental changes in position relative to the ladder stile.

Extending Levelling Device Capability

Ladders and step ladders wherever used ideally require some form of levelling to overcome slight variations in ground levels. Even internally inaccuracies of floor levels can cause problems with ladder or step ladder safety. With ladders constructed according to the present invention these problems can be overcome and the equipment made safe to use in an efficient manner.

Further problems arise when the owner needs to use the access equipment only very occasionally on surfaces that exceed the general parameters. The present invention allows the levelling devices to be physically moved or lowered thereby effectively extending the stile or leg further that than the basic system provided without compromising the strength and safety of the equipment

Mechanical fixing arrangements through the rungs of hollow rung ladders can greatly extend the strength of the lower portion of a ladder.

To Step Ladders

A step ladder has four legs and in general use the worse that seems to happen with uneven paving or surfaces is for the steps to rock or wobble between two diagonally opposite legs. At the start the user stands on the first step and it feels just fine as there is no way at that point to check stability, because it won't rock it feels safe with three feet on the ground. Around half way up the steps can become unstable and rock sideways. It is so easy to fall off if this movement is sudden. This rocking can occur even before the user is half way up as sideways pressure or slight leaning will instigate the rocking movement. Having adjusters fitted to all four legs is an option, but there is a much simpler and cheaper solution.

Due to weight ratios of the general step ladder the two main legs will sit on the ground with any surface irregularities causing a gap below one of the rear legs. With the steps level differences between the front and rear legs does not affect performance or safety as the slope angle, as with a ladder, can vary very considerably. Problems occur when the four feet are not all in the same plane. A step ladder of reasonable size is still safe even when it is sloping slightly sideways. Indeed if there will be sideways forces due to drilling etc it is reasonable to lean the steps slightly to counteract those forces. All the user needs to do is to insert a packing below one of the main feet; this might solve the rocking problem, but could make it greater.

Within this aspect of the invention all that is necessary is to adjust one of the rear legs either upwards or downwards. According to this aspect of the invention therefore a step ladder has a rest point being mid point of the leveller's adjustability. A telescopic load bearing device will remain static if so desired, by not pressing the operating handle. Thus in the midway position it will remain the same as a standard step ladder all feet in the same plane. There are three options. If the surface plane is twisted at all, there will be a gap between one or other of the rear feet and the ground. Correction of position will depend upon the starting position of the extender. Is it fully retracted, fully expanded or somewhere between? If the gap is below the adjustable leg it can be extended while if it is below the fixed leg the adjustable leg can be retracted.

If there is a gap in any position the load on the leg touching the ground will be double the correct static loading as only one of the pair is taking the load. This fact can be utilised to correct the extended position of the inner member of the device.

The standard operation of the device could remain i.e. the user has capacity of extending the inner member by pressing down the base with a foot. However to retract the expansion it would be necessary to bend down and press the pawl lever to release the ratchet teeth. This difficulty can be overcome by having the pawl assembly mounted at an increased height combined with a longer inner member.

An effective solution would seem to be the following arrangement, whereby operation of the pawl lever for either extending or retracting the telescopic device is at another location on the step ladder. A location that is easily accessible when the user is just about to climb the steps or is actually standing on the bottom step i.e. every time the steps are moved all the user has to do is to press a button that would automatically remove the gap between the rear legs and the ground. This would then become a standard procedure whenever step ladders are used.

Accidental pressing of the button can be avoided by careful and positioning and perhaps shielding. A compression spring with the button would return it when the force is removed; connection between button and the pawl device can be achieved with an inner and outer cable assembly as used on cycle brakes. Levers or similar devices are accordingly alternatives to a button. As noted elsewhere a slight angular intersection of the pawl and ratchet teeth would make it difficult to rotate the pawl away from the teeth if there was any load on the device.

The elastic return spring of the telescopic device is omitted as gravity should take over the movement of the inner component. If the pawl is retracted from the ratchet rack the inner member will drop out unless there is internal limitation of same or it reaches the ground when it will stop. If retraction is required the weight of the steps would force the inner to retract until the fixed position foot reaches the ground.

Advantages of Telescopic Load Bearing Device with Stabiliser Arms

Ladder stabilisers may comprise two legs attached to the stiles and extending to the ground outwardly and rearwardly to the ground. In some situations it is desirable to attach fitting to sections of the legs. A telescopic load bearing device has the capacity to allow fixings to the outer member above the pawl housing unit.

Fixing to Legs

Adding internal nuts to bolts in a tube is difficult, but pop rivets or self tapping screws are possibilities. These fixings can provide shear restraint at the point of fixing, but are likely to fail with high horizontal pull out forces. Where solid anchorage of components is required this can be achieved with the provision of clip-on extruded elements in the outer member's extrusion each side of the pawl housing. Metal or plastic components can be slid down to the correct position vertically above the pawl housing and can then be fixed in the vertical plane with the self tapping screw or pop rivet. This then gives positive anchorage of the component. This aspect can be further developed by clicking in a metallic type clip with outward projecting lugs which can locate behind the extruded elements. Then by sliding a plastic type unit between the lugs and tapping the same finally in position the arrangement becomes very solid and with the shear restraint will resist forces and vibrations etc which may be experienced in normal use.

Ties & Clips

This vertical adjustable variability allows the adding of ties and locking clips to the load bearing member which in turn allows stabilisers to be attached to a wide range of ladder types both during the manufacturing process and in retrofit alterations on old ladders, step ladders and other types of access equipment.

Clip on Element

The provision of clip-on elements in the outer member's extrusion each side of the pawl housing has further advantages. For example in the fixing of the pawl housing to the outer members the sliding locking action allows simpler moulding design and easier manufacturing of housing parts.

Introduction to Third Major Element—Ladder Stabilisers

A major element in the development of ladder stabilisers was to overcome the problems caused by ladder deflections during use and how to allow adequate deflections of the stabilising legs so that the base of the ladder stiles are not raised off the ground, by pivoting around too rigid stabiliser intersection points.

Ladder composites which allow a number of single ladder elements to be assembled and used in various formats such as an extension ladder, a step ladder and even an access tower may require a different stabilising capacity for each format. The base of the main lower ladder component is rotated so that any stabiliser fitted thereto would when extended outwardly and rearwardly actually project upwards and away from rather than downwards and towards the ground and clearly would then not be capable of providing any stabilising effect. The present invention of an improved ladder stabilising system includes features to overcome this and other problems.

The original single hinge hub arrangement had to have the hinge angles modified to make a more complex or compound angle at an angle across the face of the ladder stile and at an angle away from the stile.

It has been found that with a particular configuration it was possible to achieve the required outward and rearward movements of the legs from the stowed to operating positions with a hinge hub rotation of 160 degrees. In an intermediate position with a hinge hub rotation of 35 degrees from the stowage position the legs were in line with the rear face of the two ladder stiles, extending to the ground in the same plane as the ladder.

This provides a double operating position for the stabilisers when attached to composite type ladder equipment and widens the stabilisers' operational capacity still further. When attached to a ladder in a vertical position the stabiliser's legs could operate as a simple stabiliser arm in the same vertical plane as the ladder, but extending outwards from the stiles can be arranged make an access tower arrangement far more stable than hitherto.

Construction of Stabiliser Hub

According to a feature of this aspect of the invention therefore a hub unit for hingedly attaching a stabiliser to a stile provides at least three positions in which the stabiliser can be locked with respect to the stile. Typically these may be stowed, laterally outwards and outwards and rearwards. A convenient way of realising this is by the incorporation of a load transfer unit between a plate attaching the unit to the stile, the load transfer unit being lockable in any of the desired configurations, which configurations it may achieve by rotation.

Advantageously the or a load transfer unit is arranged for the transfer of substantially the whole of the forces passing between the stabiliser and the stile, thus reducing hinge pin wear.

The hub unit is most conveniently primarily attached to the stile, in the case of a hollow rung ladder, at the rung, with a further anchorage spaced thereabove or below. The fact that the hollow rungs generally project slightly laterally of the stile provides an advantage in that a hub unit plate formed to accommodate such projections can be that much the stiffer.

The Bolt-On or Detachable Stabiliser Device

According to a feature of the invention a composite ladder may have a stabiliser device which is readily attached and removed, can be attached to specific different points on the ladder components, as all three ladders sections in a composite ladder can have contact with the ground in different configurations.

An important advantage to this feature is that where a composite ladder is assembled as an access tower the stabiliser can provide sideways stability thereto.

This ready attachment/detachment can also provide a most effective stabiliser system for step ladders. For stowage and transportation the stabilisers can be rotated to be inline with the stiles. In use they can be vertical or at an angle to vertical.

These stabilisers preferably incorporate the telescopic expanding component and the mechanical fixing arrangement described elsewhere herein.

It is a further feature of the invention that any access tower combination can be provided with a stabiliser leg, advantageously an extendable stabiliser leg. Preferably there are two such stabiliser legs, and these are preferably detachably attachable to an access tower. Such towers are usually dismantlable and comprise side members having integral stiles and a plurality of rung members and several members which may function as ties or struts and which clip onto the said rung members. The stabiliser legs may be deployable on the combination in a plurality of different lateral angles thereto, for example sideways in coplanar configuration, and two other positions forwards and rearwards.

The connection between the leg and the ladder or step ladder is advantageously via three primary components; a shaped plate with rebated lower section forming part of a circle, attachable to a ladder stile with a bolt arrangement through or below a hollow rung to a similar or handed plate attached to the other stile; a cast or moulded hinge carrying component having a machined recess that clips under the rebate on the plate, is of similar circular shape thereto, but of less angular size so that it can rotate to a number preset positions in a plane parallel to the plate, the rotation and secondary fixing being achieved with a knob with a threaded bolt connecting the two components together, square with the plate; and thirdly a moulded or cast hub component that is inserted and fixed to the telescopic leg, is hinged in the vertical plane with a horizontal bolt between two side walls of the hinge carrying component with vertical rotation being locked by a removable pin between the same walls in other positions. This removable pin can be replaced by locking clip or pin arrangement projecting outward from the hub through the same side walls.

An upward and rotational force exerted by the stabiliser leg on the stile is transferred to same by the rebated plate and the recess. The overall general thickness of the plate is ideally restricted as the gap between stiles of consecutive extension ladder sections is relatively small (around 10 mm) and the installation of plates should not hinder the extension of the ladder. As only a percentage of the stile width of each section actually overlap it is possible to increase thickness of the plates where they are outside that overlap. This allows the threaded hole depth to be increased thereby reducing stress on the threads during tightening operation. During use of the stabiliser the actual forces taken by the anchorage bolt between the hinge member and plate can then be relatively small.

The combined effect of the rebated plate and the recess therein allows the hinge unit to rotate between a number of positions, a pin projecting from the latter into a shaped slot in the plate preventing unintentional downward movement under gravity and thereby aiding location and location of an anchorage bolt in threaded holes in the plate.

The extent of a machined recess can approach hemispherical so that it can hold the two components together far more effectively than a straight recess or smaller angular recess. This construction also allows rotation of hinge unit so allowing movement between positions by unscrewing the bolt and screwing it in another position.

Rotational movement of the plate in relation to the stile is typically prevented with second bolt between the two along the same lines as the other stabiliser's anchorage plate, this being dependant upon the construction of the stile.

Component Parts of a Ladder Stabiliser

Stabilisers Length of Arms

Where the telescopic extending device is provided for a stabiliser it will normally be longer than the device provided for association with a ladder stile. Indeed the incorporation of a device which is substantially the length of the stabiliser itself can be useful in stabilising a ladder on laterally sloping surface that is ground which slopes to the side of the ladder.

Stabiliser Tie and Locking Arrangements

Advantageously there are means for locking the stabiliser legs in both the deployed positions and the stowed configurations; a tie assembly between each stile and the adjacent stabiliser leg which automatically deploys and stows with the stabiliser legs; and perhaps a hinged stay for an intermediate configuration and which is manually clipped to the stile when required.

Stay Device for Stabiliser when in the Intermediate Position

According to a feature of this aspect of the invention the stay may comprise a hinged link member attached to the stabiliser leg at an angle to the line of the leg with manually operated connection to the stile when in the intermediate operating position and a holding clip to keep the link member held when in the stowed position. The device may also be sprung loaded with a helical spring working along the same line as the hinge. This would hold the link member against the leg automatically in the stowed position and would reverse the vertical orientation of the catch to the ladder stile as the force would be upwards. Whilst the hinged link member may be attached to the ladder stile to engage a clip on the stabiliser leg there is also scope for the incorporation of a clip on the stile with hinged link attached to the stabiliser leg.

The Main Tie Device

According to a feature of this aspect of the invention the tie may comprise a tie link member and a flexible strap, the tie link member being attached via a hinge to the stabiliser leg and the strap being attached to the link member with a manually adjustable connection and anchored to the ladder.

Swivel Base Unit to Tie Link

The hinge attachment of the tie link member may incorporate spring means to bias the link member towards a stowed configuration. Between the stowed and operating positions the tie link may rotate in one plane the same as the stabiliser leg i.e. around 160 degrees, and in a plane square to this the rotation is around 90 degrees. Preferably the rotation of the strap is catered for, thus reducing fatigue due to twisting.

To attach the base unit to a leg the metal clip with a sliding insert concept may be employed whereby the metal clip is the connection member which holds the leg in the stowed position and the base unit is the sliding insert which locks the assembly in the correct yet adjustable position.

The Tie Link

The tie link member is preferably arranged to hinge/swivel upwards when the stabiliser is being stowed and the arrangement and positioning of the components is advantageously such that the effective strap length=1 rung pitch+link member length, and strap length+link length is the overall tie length for when the stabiliser is fully deployed. In this way the strap will be substantially taut when the stabiliser is stowed and will therefore not flap about. The small upward vertical movement of the stabiliser leg assembly when locking into the stowed position allows a slight increase in tightening of the tie components in the stowed position.

The Strap Anchorage

Concerning the anchorage of the strap to the ladder, where, as is usual, the ladder rungs are hollow, a plug may be fitted at both ends of a rung and constructed to allow a tie strap to pass there through and be anchored in the plug on the opposite side of the ladder. Advantageously this ladder strap anchorage is arranged to rotate with respect to the ladder so that the strap does not twist significantly between the deployed and the stowed configurations. This simple cheap configuration can be used with a ladder levelling device fitted within the hollow stile of the ladder. The strap may be connected to a metal or plastic clip which will be free to rotate in the vertical plane and be connected to the core element by a bolt with sleeve to allow that rotation.

Clip on Stay Base

The tie base may also carry a clip arranged for locking the stay to the ladder in the stowed position. Preferably there is a fitment having a pocket and the tie base has a clip carrying a tongue, the clip being slidable so that the tongue enters the fitment pocket which is associated with a ladder rung and this is likely to be a rung next above that with which the strap anchorage is associated. The clip and tongue locations can be reversed.

Vertical Movement of Stabiliser Leg

Preferably spring loaded means are provided whereby the stabiliser locks into a deployed configuration and has to be pulled or pushed down with respect to its attachment to the ladder in order to release the lock. This same spring-loaded means may be arranged to constitute those by which the stabiliser stowage clip is extracted from or connected to the stowage pocket.

Different Length Straps

To cater for ladders of differing rung pitch in a stabiliser assembly which may be provided for retrofitting to any one of a number of ladders the stay base may be adjustable to ensure that the strap is slightly under tension when stowed on any ladder.

Stabilisers With or Without Levelling Elements

The above described stabiliser stay arrangement may be mounted on a ladder/stabiliser assembly which does not incorporate levelling means in accordance with the earlier aspect of the present invention.

Stabiliser Extra Ties

Where the lateral ground slope is steep the difference in length between the two stabiliser legs can be substantial. The longer stabiliser legs being the more flexible by comparison with the shorter can give rise to an unwanted instability of the ladder/stabiliser assembly. According to a feature of the invention an additional tie may be provided to resist the excess bending of the longer stabilising leg. The tie may conveniently be a two part strap, each part stowable on each stabiliser leg so always available for use. There could be two pairs of straps, but this would suggest to users that both sets should be used; this would be undesirable as unequal deflections would come back into force.

Bolt-On Stabiliser

This aspect of the invention also provides an extending leg detachably attachable to a hub unit to allow rotation of the leg away from a stowed position parallel to ladder stile to a vertical plane away from the stile. The hub unit can rotate around a horizontal axis to a number of preset or variable positions.

Mechanical Fixing to Ladder Stiles

The traditional nut and bolt type fixing of equipment to modern ladders stiles can causes problems, especially when new equipment is to be fixed to existing ladders by drilling holes through the stiles. Ladder manufacturers tend to condemn such drilling of stiles on the ground that this would reduce the performance of their ladders. However since stiles have 25 mm×25 mm perforations at approx. 270 mm centres to hold the rungs, holes within the centre section of stiles in line with rungs will not cause significant reduction in ladder strength. Nevertheless as bolt fixing through hollow stiles can cause collapse of the stile section due to excessive tightening, this should be avoided especially where the bolts will take considerable forces as with ladder stabilisers.

Consequently a particularly reliable position for fixing stability equipment is through the hollow rungs. Moreover, a particularly suitable rung bolt assembly consists of a threaded bolt arrangement comprising of a slightly shorter bolt or rod threaded at both ends with an internally threaded hexagon member like a long nut that is attached at each end. To prevent rotation of the assembly a lock nut can be fixed within the threaded members at one end. The unit would be pushed through the rung and pair of injected moulded plastic components of the internal shape of the rung with a perforation the size and shape of the threaded member placed in the rung with the bolt in the desired position. The assembly can then accept a bolt through the device to be attached, but this simple version may require devices both sides of the ladder so that forces are shared. Holding the threaded member in the plastic component allows the unit to transmit lateral forces to the ladder stile. Both the attached devices will be pulled tight against the projecting end or the rung so that friction will also help in transmitting lateral forces, providing full restraint on the device attached.

In order for the attaching bolt to be removed at any time during use of the ladder, a shaped pressed metal clip with bent over lips can be inserted into the rung so that the lips click on the end thereof. The bolt can then be inserted through holes in the clips and the threaded members attached at each end. These are tightened and then the plastic blocks are inserted, which will prevent the lips from being forced off the end of the rungs. The same blocks can accommodate both options. The position and rotation of the threaded members can be constrained so allowing the use of these for attachment purposes.

Where there is no hollow rung an assembly may be employed comprising a flanged internally threaded tube and a long threaded rod or bolt. The flanged end can be circular or be shaped to allow rotation using adjustable spanner. A further option has the flanged threaded tube threaded on both the outside and the inside. These can be fitted in various ways depending upon the design of the access equipment to which it is being fitted. With step ladders where there are no rungs but rather steps or a strut between the rear legs the capability of securing add-on devices with the simple bolt arrangement could be included during manufacture. There are a number of cross sectional details included with this patent specification.

To provide rotational resistance to a device secured to a hollow ladder stile has always been problematical due to the thinness of the aluminium used. One solution hereby proposed involves the deformation of the stile's wall into a recess formed in the device being attached. A hole is drilled through the stile using the device being attached as a guide or jig. Then the hole is enlarged on the inner side of stile to accept a threaded flanged component of the correct length with the head taking an Allen Key for tightening same. This is inserted through the enlarged hole from between the stiles and connects to a bolt inserted through the device being attached. All that is then necessary is to tighten both the bolt and the flanged component and the stile wall will be deformed into the recess, so transmitting the rotational forces along a greater surface rather than just a small diameter hold through a thin wall thickness.

The fixing of a device to the alternate assemblies can be by various types of bolts from standard hexagon headed bolts through countersunk Allan key headed bolts to knobs for the rotation and tightening of same.

Colour Coding

Levelling devices on both the ladder stile and the stabiliser may be colour coded, for example red towards their innermost ends, to indicate that the device should not be extended further or has already passed maximum safe extension. Where a tie is provided then a further colour code may be applied to the levelling device, for example orange, to indicate that the tie should be used. Additionally a printed legend may indicate the meaning of the colour code(s).

Other Uses

It will be appreciated that the above described construction may be employed in various contexts where a second member is to retract and extend from a first member. Tripods and other forms of stand, trestles, tables, chairs, scaffold and tent poles, for example, and lifting devices are among the many possibilities. In some of these contexts, for example scaffolds, stabilisers and extender devices in accordance with the present invention may both be provided.

Where however for a ladder the pitch of the ratchet teeth may be of the order of 5 to 10 mm, preferably 6 mm, in a tripod or easel where level may be a yet more sensitive issue the pitch can be reduced; this would make the size of the overall assembly smaller with less sideways projections from the outer member.

Jointing System for Hollow & Other Section Ladder Stiles

Existing “surveyor” ladders that can be broken down into short sections for transport of same within a car boot etc have an intersection arrangement whereby a plug element is fixed to one ladder section and is inserted by the user into the next and a clip or bolt is tighten to ensure transfer of force between sections. In order to allow the insertion and removal of plug it is necessary to have clearances between the surfaces otherwise the user has trouble. These clearances then reduce the load bearing capacity of joints which have a tendency to deflect or the ladder bends. To overcome these problems the length of plug overlap has to be extended.

Surveyors inspect properties, so often it is necessary to have a ladder of that is longer than presently available in the breakdown format. Extra lengths can be purchased, by buying two ladders and putting them together, but this is not recommended as ladder deflections become large. Also surveyors never know what ground conditions they will have to overcome so the stabiliser and levelling device would be an ideal solution and would make their ladders much safer.

Instead of having a single plug attached at each stile joint, there may be provided two half stile depth (the larger dimension) projecting components with each secured to a stile section. When jointed the overlap is increased to twice the projection. To achieve maximum load transfer and thus reduce bending of the ladder the two elements can be expanded across the depth of the stile by simple rotating double acting cams. These can push the two elements apart so expanding to fully fill the internal space within the stile in the depth direction. It is not necessary to expand width as the sides are only webs connecting together the stress elements the outer edges or surfaces.

It is a very important advantage of the aspects and features of the present invention that the various components may be quite versatile and susceptible of use with a variety of ladders, step ladders and access towers etc, making yet further reduction in manufacturing and purchasing costs. For example, even the projecting unit can be constructed for use with a variety of ladders etc. Perhaps only a part of the hub unit may be handed but being capable of manufacture by injection moulding the manufacturing costs of these items may be minimised.

Due to the way the units are rotated by 180 degrees rotation of the cam knobs on a pair of units attached to two stile sections can be in the same direction to lock the components together, yet internally the cams may rotate in the opposite direction in relation to their internal bearing surface. This makes all knobs rotate in the same direction to achieve locking together; turning through 90 degrees so that the knobs face down the stile and all ladder sections will come apart.

The cams can be mounted within the stiles so as not to be exposed. The expansion requirement of the components is minimal—around 2 mm to achieve total locking and this can be achieved with 90 degree rotation of the knobs, so the available mechanical leverage can be substantial.

The projection unit may be constructed from an aluminium extrusion ‘U’ shaped with an internal load bearing cross member. To accommodate different sized ladder stiles one then need only vary the depth of the hollow section, the ‘U’ remaining constant. Sliding within the ‘U’ may be a handed pair of injection moulded plastic polycarbonate components.

Installation may then require just placing the internal cam between the handed pair of mouldings and pushing it into the extrusion; thus also giving a plastic end to the unit so it will be protected against damage. The projection will also protect the exposed end of the ladder stile. The unit has only to be fixed within the stile by simple screws through into the inner plastic component.

As this device can provide high bending resistance of ladder stiles at the joint thereof it can enable ladders to be extended or split thus achieving extended utilisation beyond the basic ladder. For example:—The upper ladder section of a triple composite could be split in half so allowing the middle section to be extended downwards to pick up sloping ground or different floor levels as with theatres and still extent the middle section upwards to greater height. Another use of a split top section would be to use the two halves horizontally as vertical handrail elements within an access tower arrangement. The reduction in stile depth on the joint position would assist with using composite ladders within access towers as this will accommodate the difference in ladder width between the ladder sections of the usual extension ladder.

The capability of building up length of ladders by adding components can make roof ladders more effective as there will just one unit up the full height of roof, making damage to roof tiles etc far less likely. Large commercial roofs present another area where such ladder extending capability would be an advantage. One can just bring up a pile of shorter ladder sections, put two on the roof, join them together, push them across and add further sections likewise. In this way one can form a long safe platform for use on a relatively flat roof or even on a traditional scaffold. Boards can be placed upon the ladder if desired. Alternatively this principle of extension may be applied to boardwalks as such.

Also, this system is very suitable for use on pitched roofs, particularly those which are longer, eave to ridge than any standard ladder. Indeed one may have a suite of relatively short ladder portions, one with or having attachable thereto a ridge hook, the remainder being attached as one feeds the ladder combination up the roof.

For the private user in particular this means that he may be able to have a suite of such ladder portions stored in a short space, like a garden shed.

To keep down overall length of the sections while still providing reasonable levelling capability one may modify the connection so that its projection in the dismantled condition is reduced.

Visual Safety Unit

According to another aspect of the invention a ladder may incorporate a safe inclination indicator device for indicating whether the ladder is at a safe angle for use.

The indicator device may comprise a datum plate associated with a ladder stile, a rocker shaped to flip between one of three configurations on the plate, a yoke arranged to constrain the rocker to the plate and associated with a weight, and an indicator associated with the rocker, the arrangement being such that if the ladder is inclined too steep or too shallow the rocker flips to one side or the other and “unsafe” is indicated. The indicator may further be arranged to provide a “safe” indication. Typically the “safe” indication is a green panel within a viewing aperture and an “unsafe” indication a red panel within the viewing aperture.

The rocker may be recessed at the centre thereof and the yoke may have a roller arranged to roll within the said recess and thereby to rock the rocker.

For a ladder provided with stabilisers a stabiliser datum plate may be provided adjacent the ladder datum plate such that non-deployment of the stabilisers causes a non-alignment between the two datum plates and the rocker will tip to unsafe at a specified ladder inclination steeper than when the stabiliser is deployed. In this embodiment of the invention the safe inclination indicator device may be incorporated in the hinge support assembly by which the stabiliser is attached to the ladder.

Typically a ladder not fitted with stabilisers is safe when leaning at an angle from 71 to 76°. With stabilisers the range can be increase to 60 to 76° or to whatever is required. The actual points of movement of the rocker can be varied during the, manufacturing process by changes in angles and shape of the curve the roller runs on. This will change actual flipping angles.

The indicator device is preferably arranged to be clearly visible from the standing position just prior to climbing a ladder. An alternative safe inclination indicator device has an LED. This can be arranged to give an indication in respect of both forwards and sideways leaning. The device may also solar recharging, battery and automatic timing only showing display for limited period thus making the device always available especially if the electronic elements are totally sealed.

### BRIEF DESCRIPTION OF THE DRAWINGS

Devices in accordance with the invention will now be described by way of example with reference to the accompanying drawings, of which:

FIG. 1 is a vertical cross section of a typical load transfer arrangement between two telescopic components;

FIGS. 1a, 1b, 1c illustrate the potential range of cross sections that are possible with this invention, from ladder levelling device, stabiliser leg construction down to an expanding table leg;

FIGS. 2a, 2b, 2c illustrate a basic construction arrangement of the ratchet arm device or pawl;

FIGS. 3a, 3b, 3c, 3d show the installation of load transfer assembly within the outer telescopic member;

FIG. 4a shows movement of the pawl ratchet mechanism when user extends the device by applying downward pressure on the foot;

FIG. 4b shows the upward movement or retraction of the telescopic member achieved by user pressing outer lever part of the pawl assembly;

FIGS. 5a, 5b, 5c, 5d illustrates the movement of the pawl locking mechanism.

FIGS. 6a and 6b depict a levelling device too short to reach the ground; the locking mechanism will not lock and foot will retract;

FIG. 7 shows a ladder positioned on sloping ground fitted with levellers and stabiliser to give a far safer ladder to climb;

FIG. 8 illustrates how composite ladders are changed from a step ladder version to a standard extension type ladder:

FIG. 8a illustrates stabiliser and levellers to composite extension type version as FIG. 7

FIG. 8b illustrates stabilising leg requirement for composite step ladder versions:

FIG. 8c shows how two ladder sections can be used to form an access scaffold that will simply adjust for placement on sloping ground;

FIG. 8d shows a simply modified version of ladder stabiliser to project stabiliser leg in line with ladder stiles, additional linking component;

FIG. 8e illustrates a detachable stabiliser attached to composite type step ladder arrangement;

FIG. 9 shows a table that is level when used on sloping ground:

FIG. 10 shows elevation of an extending ladder fitted with foot levelling device and stabiliser in the closed position;

FIGS. 10a-10d shows details of the stabiliser's hub and hinge assembly:

FIGS. 10e-10f illustrate the hub's compound hinge angles

FIGS. 10g-10h illustrate operating hub hinge angles on the thrust plate

FIGS. 11a-11d show cross-sections at various stations over the length of the stabiliser stay base;

FIGS. 11e-11g show cross-sections of the tie flexible scrap anchorage to ladder

FIGS. 12a-12c show cross-sections of the swivel/stable base unit

FIGS. 12d-12f illustrate the attachment of a stabiliser swivel/stable base to a stabiliser leg and the operation of an associated stowage clip;

FIG. 13 is an elevation of the stabiliser leg when secured in line with ladder stiles by extra link. Detail of FIG. 8a

FIG. 14 is an elevation of a ladder type access scaffold stabiliser as depicted in FIG. 8b showing a levelling and stabiliser arrangement to improve safety;

FIGS. 14a-14g show details of the removal hub for the access stabiliser FIG. 14;

FIG. 15 illustrate load transfer arrangement between stabiliser components and hollow type stiles.

FIGS. 15a-15f illustrate load transfer arrangements between stabiliser components and hollow type stiles using hollow rungs.

FIGS. 15h-15k illustrate load transfer arrangements between stabiliser components and ‘C’ section ladder stiles;

FIG. 16a illustrates the fitting of ladder levelling assembly to hollow section ladder;

FIG. 16b illustrates the fitting of ladder levelling assembly to extruded ‘C’ section type ladder;

FIGS. 17a-17e shows detail of inner extruded telescopic sections fitted with bearing to reduce friction with the outer member;

FIG. 18 illustrates step ladder use and problems therewith;

FIG. 18d-18f illustrates a step ladder levelling adjuster;

FIG. 18g-18k illustrates step ladder stabilisers & a levelling device;

FIG. 19a-19g illustrates extending and splitting of hollow ladder stiles—the developed jointing system;

FIGS. 20a to 20d illustrates a basic mechanism for the ladder safe angle indicator;

FIG. 21 illustrates a stabiliser deployed;

FIGS. 21a to 21d are sketches showing a ladder safe angle indicator incorporated into a ladder/stabiliser hinge, with the stabiliser deployed;

FIG. 22 illustrates a stabiliser stowed;

FIGS. 22a to 22d are sketches showing a ladder safe angle indicator incorporated into a ladder/stabiliser hinge, with the stabiliser stowed;

### DESCRIPTION OF PREFERRED EMBODIMENTS

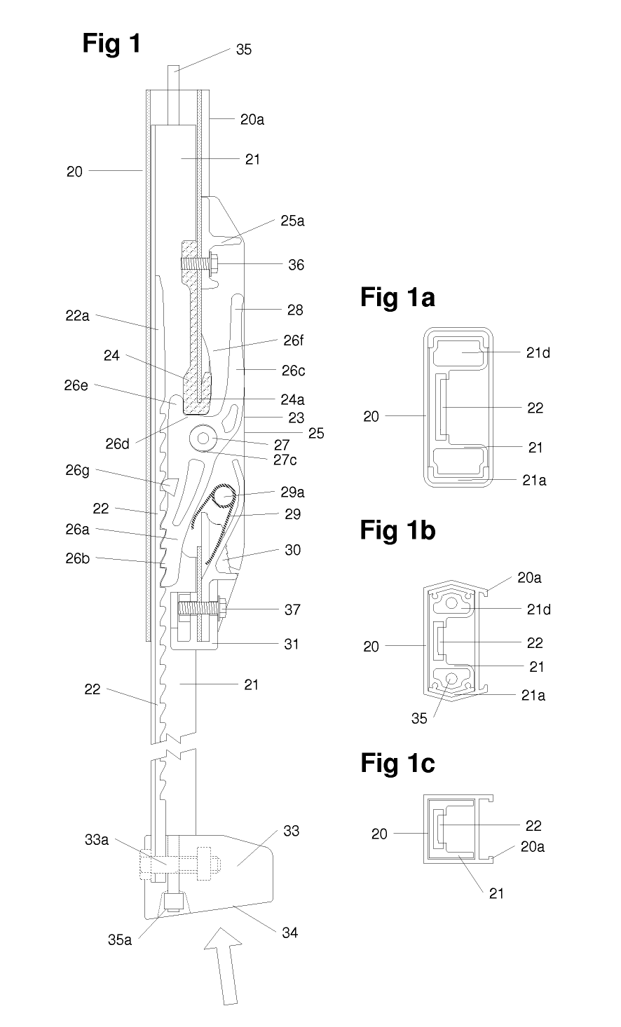

FIG. 1 show the vertical cross section of the general arrangement of a telescopic extending device.

The device consists of an outer member 20 that can continue upwards beyond the diagram, an inner or extending member 21 that moves vertically in relationship to the outer member 20. Attached to the member 21 is a rack of ratchet teeth 22. The up and downward movement of the member 21 is controlled by a pawl assembly 23, which comprises a load transfer element 24, a housing assembly 25, a pawl 26 comprising a pawl arm 26a, a plurality of ratchet teeth 26b, an operating lever 26c a pawl shoulder 26d, a projection 26e and a pivot pin 27. The rotation of the pawl 26 about the pin 27 in use is limited to around 7 degrees; during installation of assembly the rotation movement is greater.

The operating lever 26c is arranged for pressing by the user to separate the ratchet teeth and is situated outside the member 20. The pawl shoulder 26d transmits loads from the member 21 via the rack 22 and the pawl teeth 26b to the load bearing element 24 that is attached to the outer member 20. Between the member 24 and the rack 22 the projection 26e that has a number of functions depending upon the use and construction of the device, the main being to prevent the outward movement of the pivot 27 when high loadings are encountered. The gap 26f between the members 24 and 26c can be filled with part of the locking mechanism elsewhere described in this document. With the gap 26f filled the rotational movement of pawl will be totally restricted so that under load conditions the separation of the ratchet teeth is prevented. Forces between the pivot 27 and the housing 25 will be minimal so allowing simplified construction of the member 25 and its fixing to the outer member 20. With the above elements the strength capabilities of the device is greatly increased and the construction of the housing 25 is simplified.

FIGS. 1a, 1b and 1c show the possible sectional relationships between the elements 20, 21 and 22. These are dependant upon the utilisation of the device.

FIG. 1a shows the outer member 20 as a hollow ladder stile with inner member 21 running inside same and a wide rack 22 to take the relative high loading and with a sliding membrane 21a between members 20 and 21 to aid easy extension of the ladder leveller in this format.

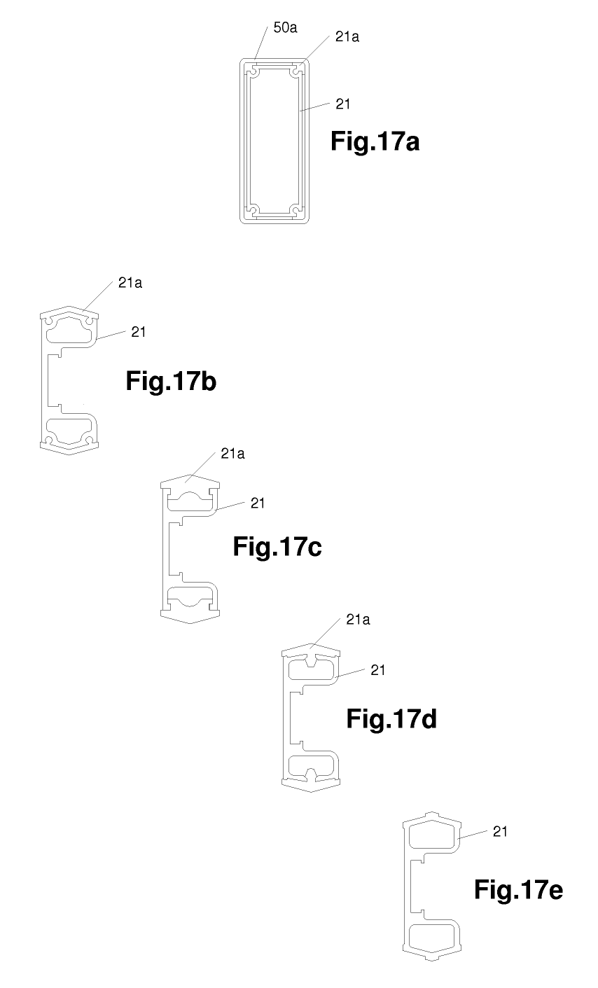

FIG. 1b shows a ladder stabiliser leg with less loading and therefore smaller rack 22, but as movement is large a spring element 35 is included which could also be included in FIG. 1a. Sliding element 21a is of different construction as longitudinal movement of 20 relative to 21 is considerable. Further variations of this element 21a are covered in FIG. 17a-17e.

FIG. 1c shows a table leg adjuster where vertical movement is small in relationship to overall length and loadings are low. With both the FIGS. 1b and 1c embodiments there is an extruded catch arrangement 20a that aids installation of 23 the pawl ratchet assembly and other components.

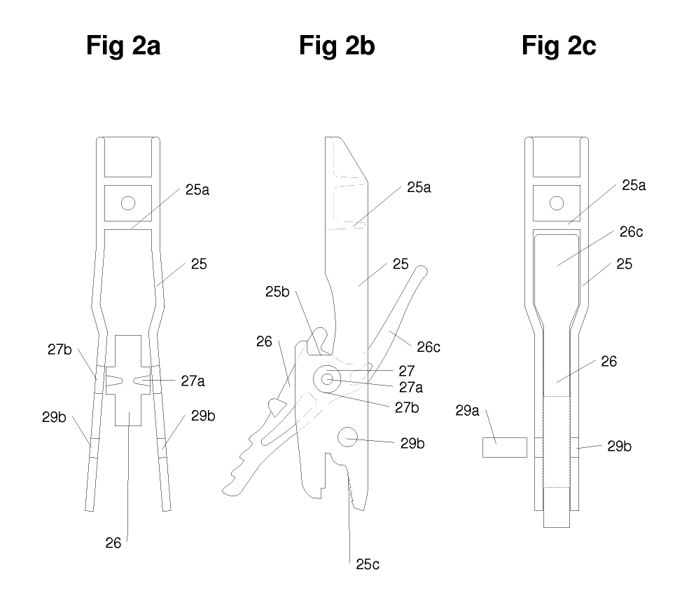

FIGS. 2a, 2b and 2c show the relationship between pawl 26, the housing 25 and the pivot 27. Generally the pivot for pawls cause problems as a hole is required through the pawl to accept the pivot, this increases stresses around same. With this device there is virtually no load taken by the pivot 27 so that it can be formed as part of the pawl device 26 without being a separate component. This allows the pivot diameter to be increased without detriment to the strength of the pawl device 26; while injection moulding volume around this point may be reduced with a small recess 27a.

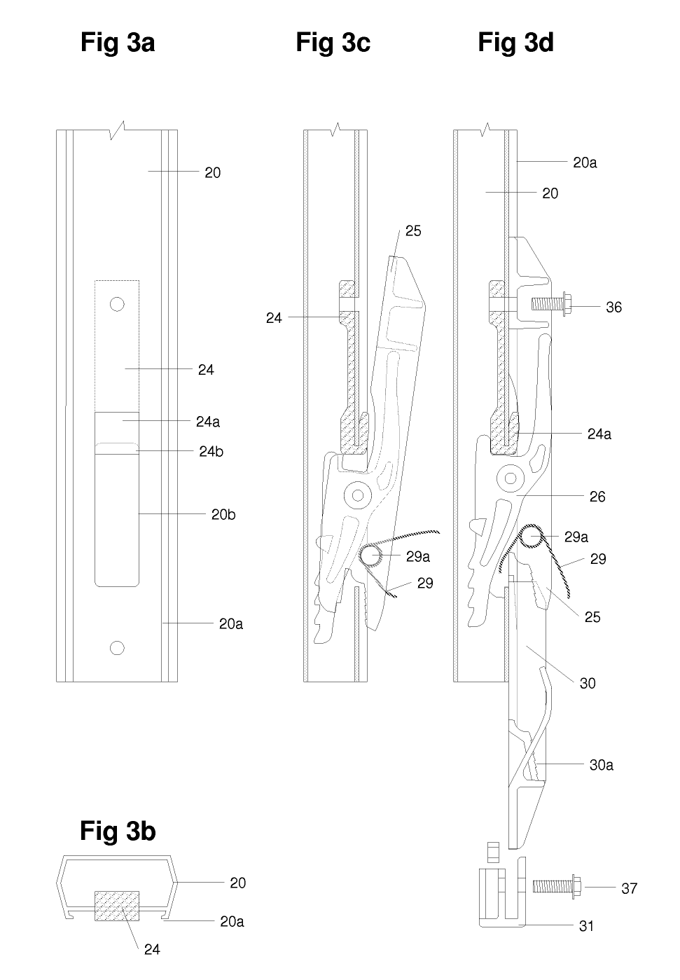

The housing 25 is an injected moulded plastic component with two semi flexible wings which have perforations 27b and 29b. The pawl 26 is simply pushed into place as shown in FIG. 2a with the pivot projections 27 being inserted into the perforation 27b which then allows the wings to become parallel. FIG. 2b shows pawl within the housing 25 together with recesses that allow the housing to be partially inserted within the outer member 20 through a cut out 20b as in FIG. 3a.

FIGS. 3a to 3d shows the installation of the pawl assembly. The load transfer element 24 has a recessed thrust plate 24a at its lower end whereby it clips to the outer member 20 through a perforation 20b that has radial corners to reduce stress at the point of vertical loading contact between members. The thrust plate 24 will be an aluminium extrusion with slight machining to the interface 24b. With radial corners 20b is easier to cut with rotating cutter. The combined parts 25 and 26 are inserted as FIG. 3c and pushed up to the load transfer 24 and a bolt 36 inserted.

There are times when it would be advisable for the construction of the load transfer element 24 to be varied, for example when the outer member 20 is of hollow steel rather than aluminium, to prevent corrosion between the two parts, 24 would be of steel rather than extruded aluminium. The inner member 21 could still be of extruded aluminium as metallic contact is prevented by the friction reducing member 21a.

The helical spring 29 is temporally positioned on pin 29a, between the faces of the pawl carrier 25. This is shaped to assist fitment thereof to a ladder stile or outer member 20 while a combined wedge and holding member 30 and anchor 31 serve to lock the pawl carrier to member 20. The wedge member 30 and the associated face of the carrier 25 are serrated 30a to assist assembly and retention. In this example unit 30 slides within 20a, though this is not essential. The actual detailed construction of 25 and 30 will depend upon whether there are recesses 20a along the outer member 20.

The anchor 31 carries a lock-nut and a sealer brush, (not shown). The lock-nut assists in ensuring retention of the assembly while the sealer brush performs the dual task of facilitating the placement of the anchor 31 and preventing the ingress of dirt to the working parts. The anchor 30 also assists the retention of the helical spring 29 which is compressed during the slide in of 30. The anchor 31 will also act as cushion to prevent impact damage between the foot 33 and the lower end of the outer member 20.

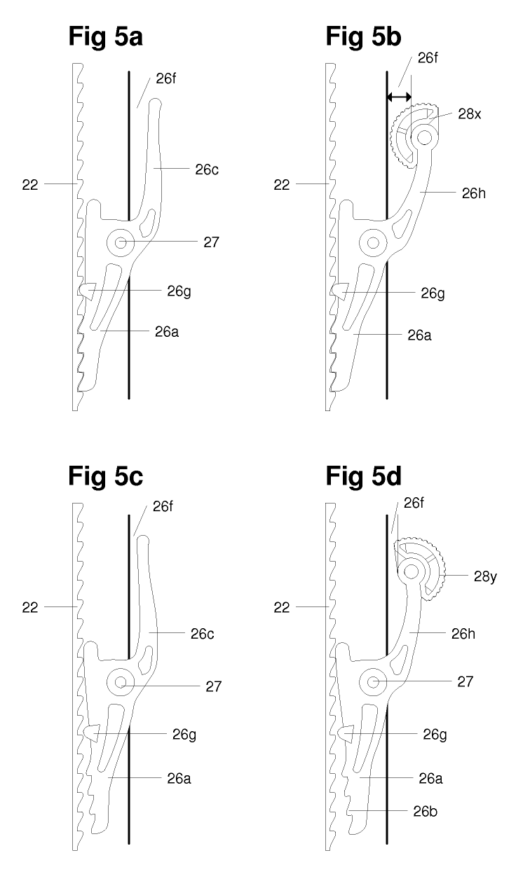

The pawl carrier 25 carries a lever shield 25a arranged for prevention of inadvertent depression of the control lever 26c. However depending upon the required load capacity of the device the control lever 26c can also carry a thumb-operated lock 28 as shown in FIG. 5b where it is shown in the locked position 28x, occupying the gap 26f and preventing rotational movement of the pawl 26. FIG. 5d shows the lock 28 in the unlocked position 28y allowing rotational movement of pawl 26. The lock 28 is so formed, of plastics material, as to show red when not in the locked position. When in locked position the knob is not visible from above because of 25a which also protects 28 from inadvertent inward movement.

The pawl arm 26a carries a nylon or low friction block 26g for preventing the pawl teeth 26b from rubbing on the rack member 22 when the extension member 21 is pulled outwards from 20. In a preferred embodiment however, the pawl arm 26 is itself also formed of nylon, but with higher loading this may be required to be of higher strength therefore made of filled polycarbonate.

The pawl carrier 25 has recesses 25b to accommodate that part of the thrust plate 24a which projects outside the stile 20.

At the base of the ladder extension member 21 is a foot pedal 33 and a ground engagement base 34.

A tension spring 35 is fitted to urge the extension member 21 to telescope back into the outer member 20. As shown in FIG. 1b the spring 35 comprises a fabric coated elastic extending down lobes of the inner member 21 through to the foot where there will be anchorage provision 35a. Alternatively where the extension capability of the device is relatively small a metallic type tension spring can be used connecting to the top of rack 22 to a point above (not shown as this is variable). The foot pedal 33 is arranged to seat against the anchor 31 when the extension member is retracted.

FIG. 3d also depicts the final operation in fitment of the pawl unit 23 to the ladder stile 20. The earlier steps in this operation are shown sequentially in FIGS. 3a to 3e. In FIG. 3a the outer face of a stabiliser leg 20 is shown. It has a rectangular opening 20a and a base slot 20b. FIGS. 3a and 3b show a thrust member 24 fitted into the opening 20a. The thrust plate 24a clips around the top edge of the opening 20a and is thus held in place while the pawl carrier 25 is next offered to the stile 20, as shown in FIG. 3c.

As can be seen in FIG. 3c the pawl arm 26 pivots with respect to the pawl carrier 25 at the pivot 27. Thus the pawl arm 26a can be inserted into the opening 20a and when it is fully there the pawl carrier 25 can be rocked to bring the base 25b against the stile 20 and fixed in place, with a screw 36. Next the wedge 30 is pushed up under the pawl carrier 25, as is the anchor 31 and bolt 37 locks these in place. The thrust member 24 has a threaded hole for bolt 36.

The pawl carrier 25 and its associated wedge 30, the pawl arm 26 and the rack 22 are all, in a preferred embodiment, moulded from a plastics material such as nylon or polycarbonate.

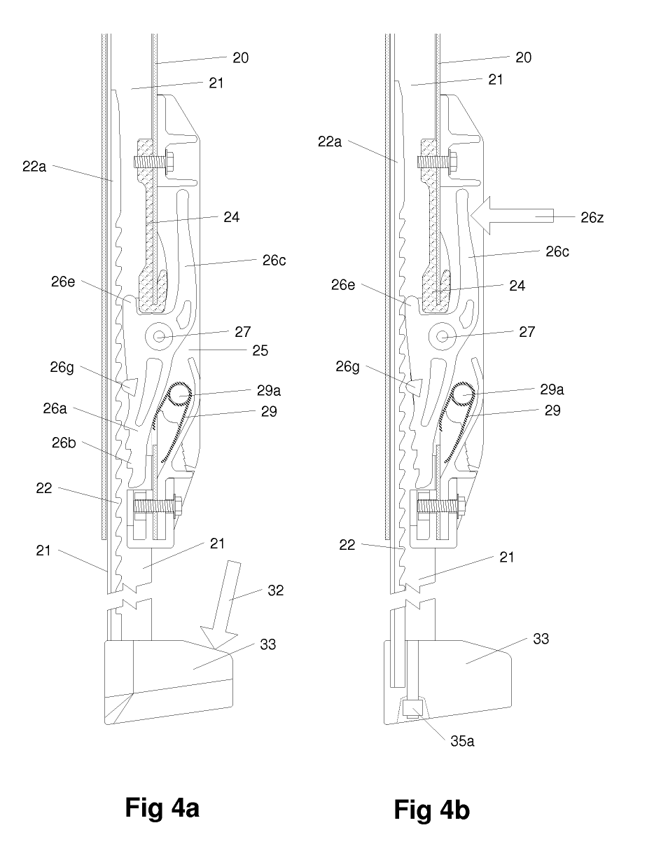

FIG. 4a shows the movement of pawl when the user pushes down 33 with foot 32, the low friction element 26g rides up ratchet teeth on rack 22 rotating pawl to clear the other teeth. Directly downward pressure is removed the ratchet reengages. When 26g reaches the top of the rack 22a, pawl remains rotated and the extension of 21 out of 20 is retracted, leaving a gap between the device and the ground warning the user that further measures are required to overcome the problem.

FIG. 4b shows how by pressing as 26z pawl is rotated clear of the rack allowing the inner member to retract automatically with the necessary forces being applied by the spring or rubber 35a. Further pressure on 26z will produce a braking effect as 26e touches the teeth of 22 this will slow down the retraction speed to desired level. Release of pressure 26z will stop the return of 21 as ratchet engages.

FIGS. 5a-d compare the operation of the pawl assemblies 26 using a lever 26c and a locking wheel 28 attached to 26h which has bearing to allow rotation of 28. FIG. 5a shows the pawl with handle 26c as previously describes in the static load carrying position with the gap 26f being positive and allowing user to depress 26c and release ratchet as shown in FIG. 5c. FIG. 5b shows locking wheel 28 in rotation position 28x that fills the space 26f. FIG. 5d shows 28y the open rotation position of 28 thereby allowing inward movement of pawl arm 26h and separation of the ratchet teeth. The circular surface of 28 will be constructed of red coloured material so will be visible from above only in position 28y. When in 28x red will not be visible from above as it is shielded by 25a in FIG. 1

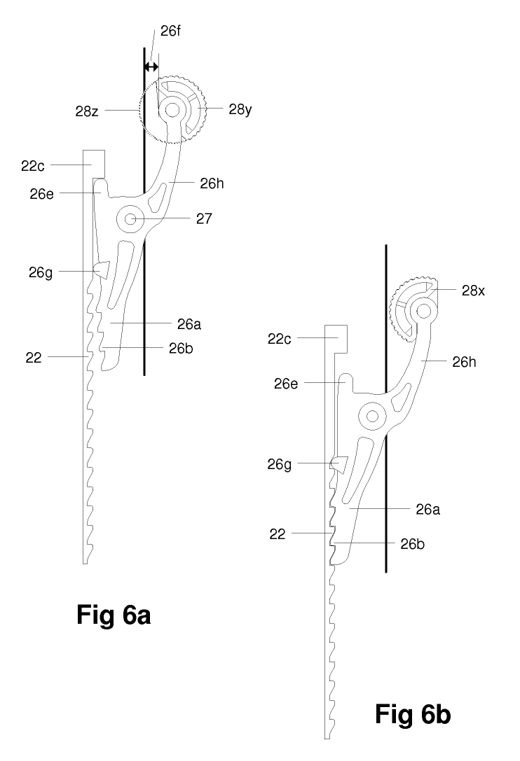

FIGS. 6a and 6b show the arrangement when the levelling device is too short to reach the ground. In FIG. 6a where there is no retractive spring the locking mechanism will not lock. With return spring installed the foot will automatically retract an amount, warning the user in both cases that there is a problem to be overcome before using the ladder.

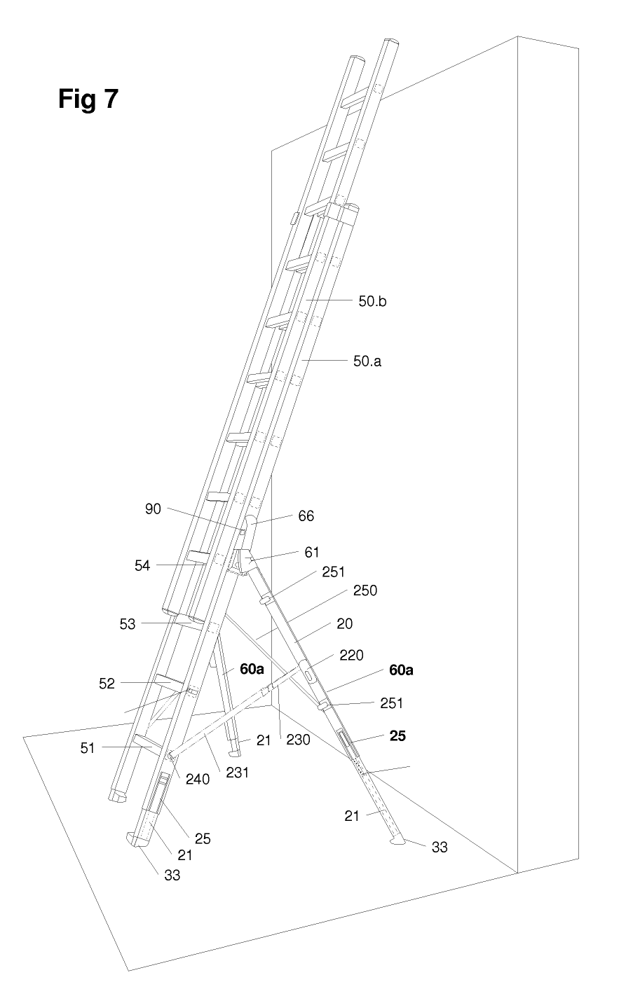

FIGS. 7-9 illustrate ways that the load bearing telescopic devices can be included within ladder and access type equipment to allow them to be used effectively and safely on uneven or sloping ground.

The following short section just shows how the various uses are related. This will then be followed by detailed descriptions of each section and further explanation of the inventive steps that have been achieved.

FIG. 7 shows a ladder positioned on sloping ground fitted with levellers and stabiliser to make a ladder safe to climb. The original design for the stabilisers is covered by European Patent Specification 1711678. Further research and development has allowed variations to the original specification. These are detailed later.

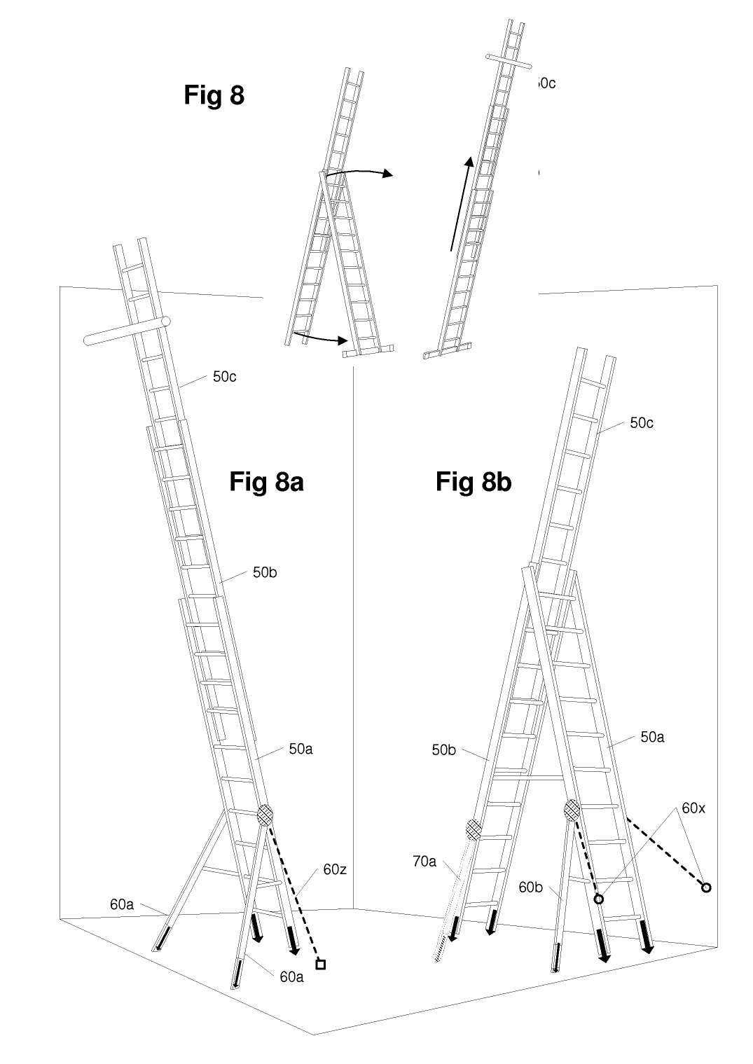

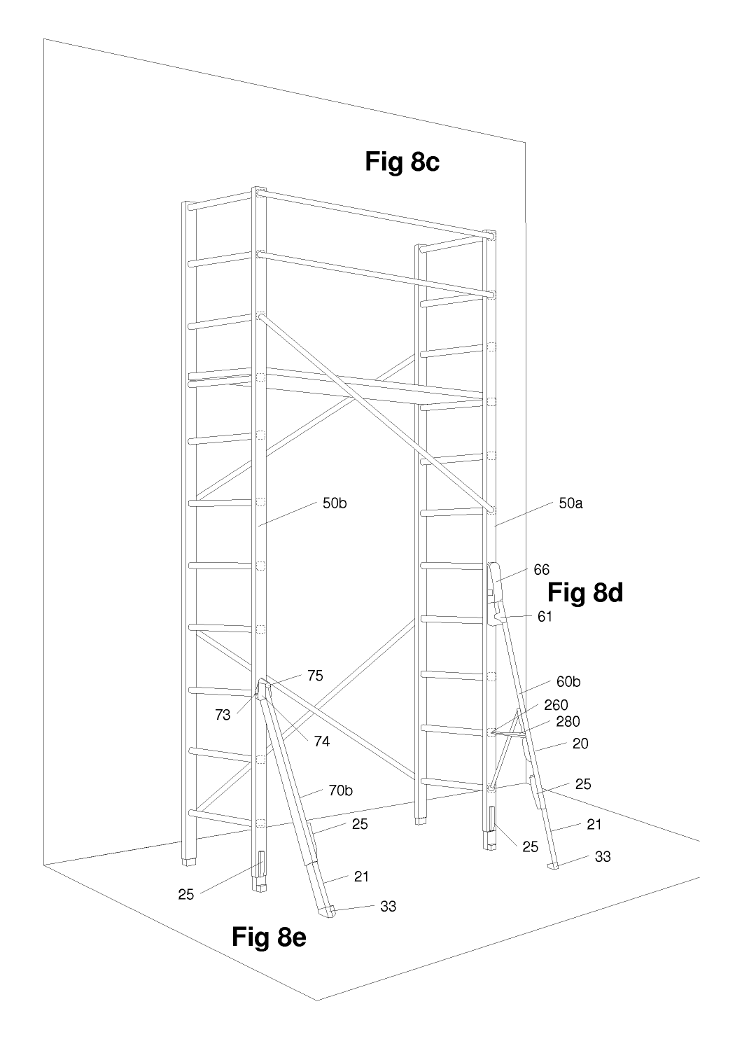

FIGS. 8 and 8a-d show ladder composites and access tower arrangements. Ladders consisting of three section extension ladders that can be erected and used in different ways are supplied with a wide stabiliser base component 59 in FIG. 8. These work well when used internally on level and even surfaces but are difficult to adjust for general external usage due to sloping ground surfaces. The figure shows the general movement of composite ladders consisting of the three sections from the step ladder variation back to a standard extension ladder.

The main variation to standard usage is the enlarged step ladder as FIG. 8b. This causes the lower section 50a to be positioned or angled so that the earlier stabilisers if extended would project upwards 60x not downwards towards the ground 60a making the stabiliser ineffective in this situation.

To overcome this problem the hub hinge angle of the stabiliser mechanism has been modified to a compound angular relationship to the ladder stile to which it is connected so that the movement between the open and closed positions is modified allowing an intermediate stopping position basically in line with the pair of ladder stiles along the same line as the wide stabiliser base component 59 referred to in the previous paragraph.

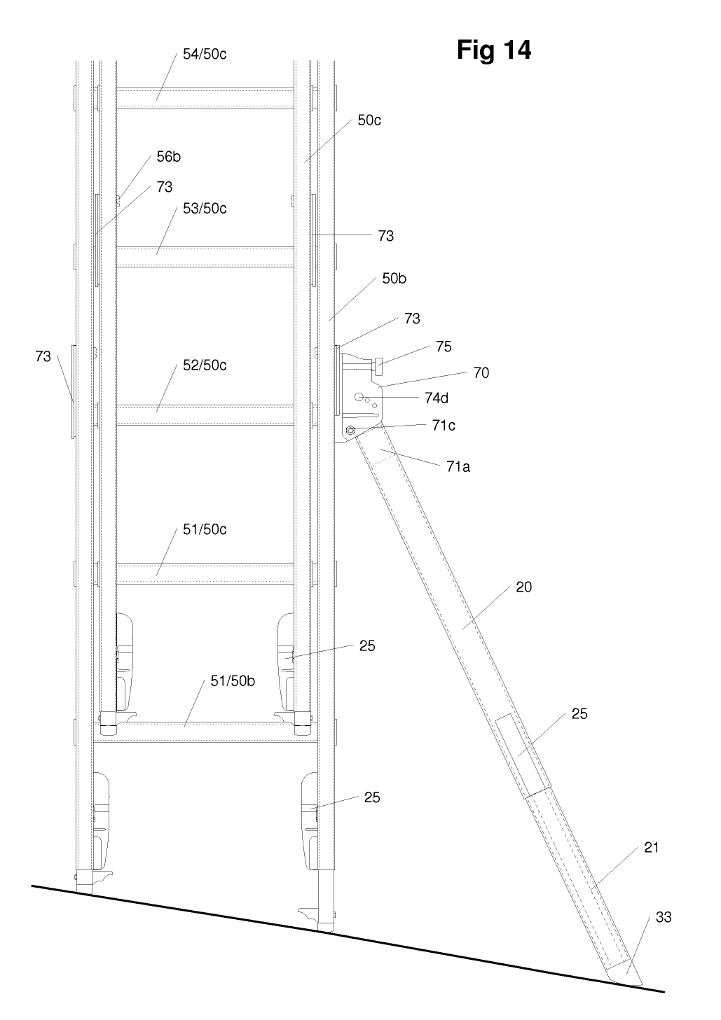

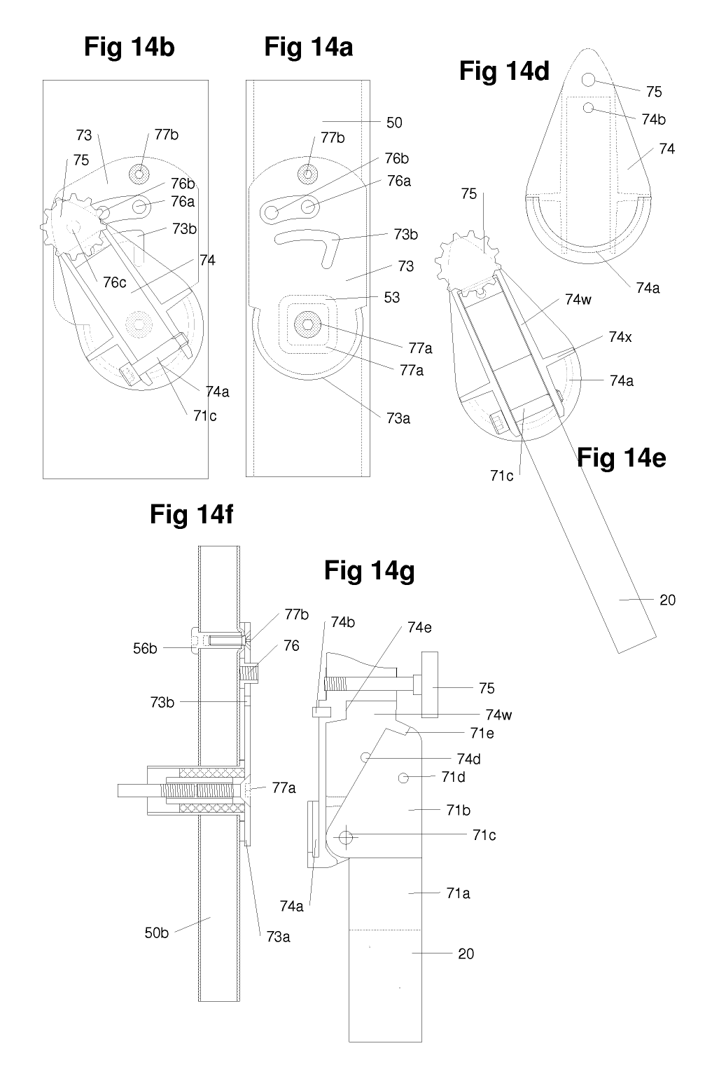

To provide a stabilising element to the other ladder sections 50b and 50c requires an easily removable stabiliser 70a further described under FIG. 14. In this position it is best set angled to the ladder or basically perpendicular.

Another use of ladder equipment is for construction of lightweight access towers as depicted in FIGS. 8c to 8e. FIG. 8c shows the general arrangement of ladder access tower using two ladder sections 50a and 50b linked together with triangular braces and an access platform. This is not complete but just shows the general arrangement. On ladder 50a the modified ladder stabiliser can be utilised to provide overturning restraint to the structure when opened to the intermediate position 60b in line with the ladder stiles as previously shown in FIG. 8b. Attached to 50b can be the stabiliser 70b projecting sideways from the stile, also in line with the ladder stiles. In this utilisation the stabiliser needs to be parallel to line of stiles not angled as previous example 70a

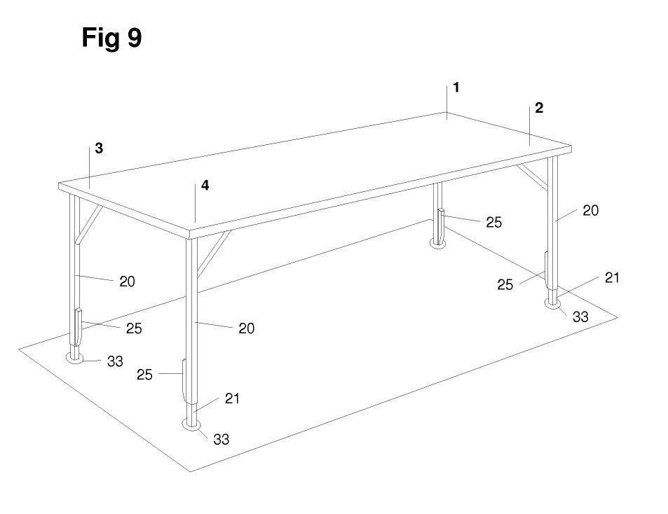

FIG. 9 shows a further version of the telescopic load transfer device inserted within the legs of a table that can be easily levelled on sloping or uneven ground. As the table is likely to be portable the legs 20 are shown with an angled brace arrangement

FIG. 1c shows a very simple cross section of the legs though with careful design a wide range of possibilities exist depending upon the visual appearance required. The projection of the pawl housings 25 could be enclosed within the leg construction or extrusion.

In use the table would be placed in the desired location with all legs retracted. In this example the highest ground point is below point 1 so the top will tilt away from there. All the user will need to do is to go to each of the remaining corners 2-4 in turn, hold down the base 33 of the extending component with his own foot and then using a spirit level could simply raise the top until it is level.

After an event the table will be upturned to close the legs parallel to the top for transport or storage. During this operation the leg extensions can be retracted and so be ready for the next use.

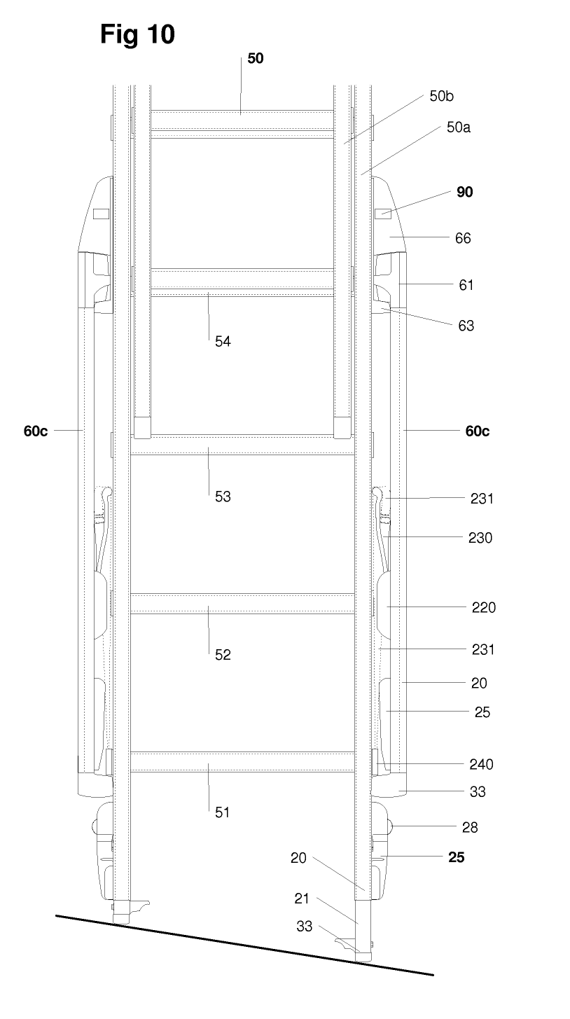

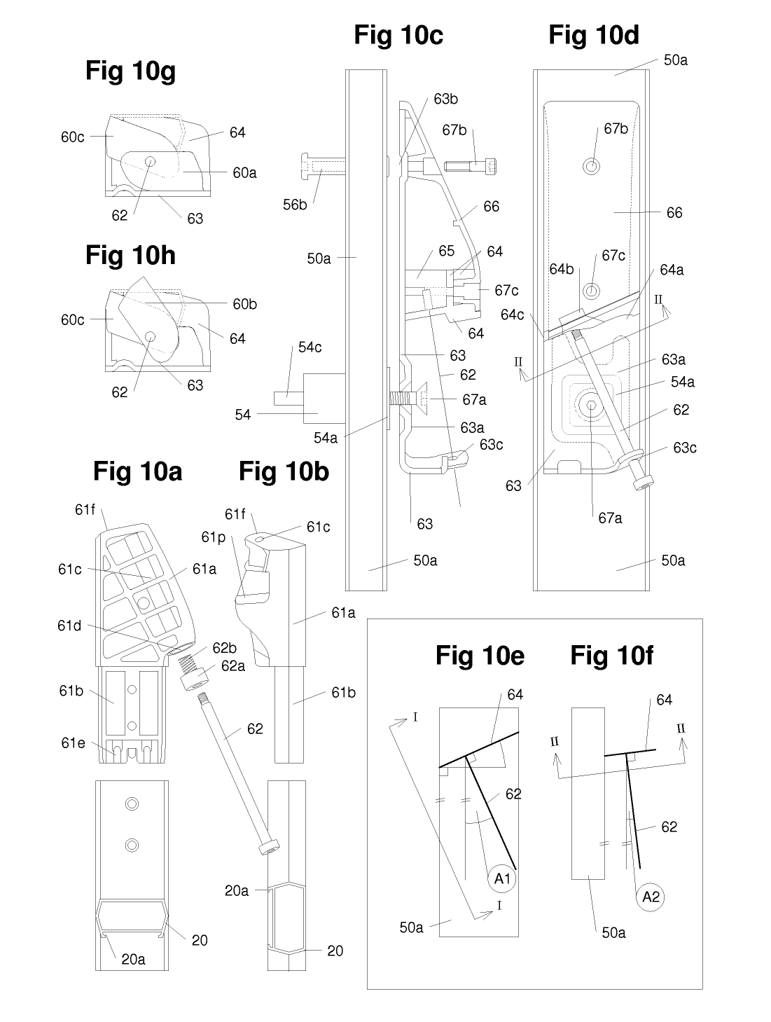

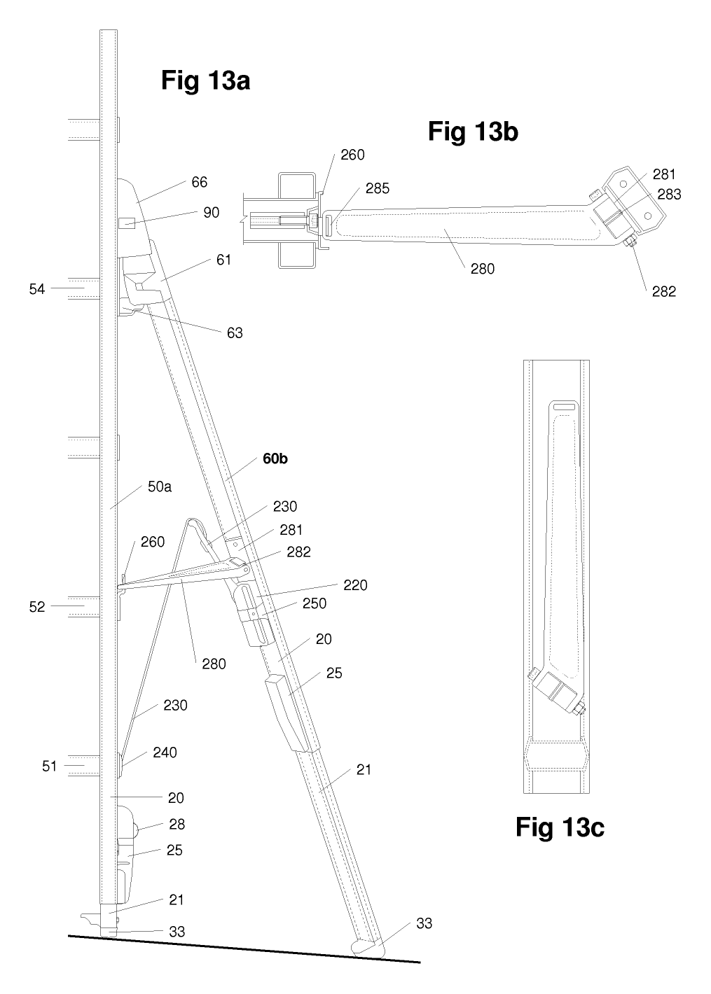

FIG. 10 shows the pair of stabilisers 60c attached to ladder in closed or stowage position. The same arrangement is also in FIG. 7 which shows in perspective the stabiliser 60a in the fully open or operating position attached to lower section of an extension ladder 50a on sloping ground. FIG. 13 shows the stabiliser as 60b in the intermediate new operating position in line with the pair of ladder stiles to which the stabilisers are fitted.

The basis elements of the stabiliser are:
1. The hub assembly consisting of 61 the moulded or cast hinge block that connects the leg extrusion 20 to the fixing plate 63 via a hinge pin 62 shown in FIGS. 10a & 10e, the cover 66 that includes 90 a ladder slope safety warning device.
2. The stabiliser leg 20 being the outer member of the load bearing telescopic device and 21 the inner as shown in FIG. 1b with pawl housing 25 and foot 33.
3. The stabiliser tie consists of a vinyl strap 231 connected to ladder with 240 of variable construction and to a rotating link 230 that folds the tie member during closing operation connected to the leg with swivel base 220 that includes part of stowage connecting mechanism.
4. Extra tie 250 between legs to be used when ground slope makes one leg much longer than the other. To keep the tie available at all times it is in two half sections each tied to the respective legs by clips 251 on FIG. 7
5. Additional operating position with hinged tie member 280 shown on FIG. 13 allowing the ladder to be used in different situations.
6. To make a ladder safer four feet are required on the ground. To achieve this on sloping or uneven ground ladder, leg or stile extenders are required.

Each element will be taken in turn showing how each effect the overall performance of the stabiliser beyond the original European Patent Specification 1711678.

The operation requirement of this stabiliser system is that in the closed position as shown in FIG. 10 all moving elements are contained between the ladder stile 50a and the leg 60 in the closed position 60c. This has required the hinge angle to be modified and set at compounded angle to the ladder stile as shown in FIGS. 10e. & 10f

FIGS. 10a-10d show the hub assembly. FIGS. 10a and 10b illustrate the main hub unit 61 being either of cast metallic construction or preferably of ultra violet resistant plastic injected moulded with polycarbonate or similar performance material. 61a is the exposed part and 61b is inserted and bolted to the stabiliser leg 20, to a similar section to that shown in FIG. 1b. Provision is included at 61e for anchorage of the telescopic retraction spring element 35 which is just one continuous length that just clips over projecting pins. The hinge pin or bolt 62 passes through 61 along 61c at a compound angle to the line of the ladder stile 50a and to the leg 20. The load transfer between the hub and the supporting components is through 61f which is square to the line of the hinge bolt 62.

The operation of the stabiliser system is the rotation of the hub around the hinge between specific points. Locking into these points is achieved by pushing down the unit at point 61p against a spring 62b which is recessed into 61d. A cap 62a protects the spring 62b and prevents the user's fingers being caught in the vertical movement.

From the static position to operating condition all that is necessary is for the spring 62b to be depressed, the hinge can be rotated to either of the operating positions, releasing pressure will allow the hub to automatically lock in desired location. In the three stabiliser positions 60a, 60b & 60c the hub locks into recesses in the load transfer component 64 in positions 64a, 64b & 64c as shown in FIG. 10d.

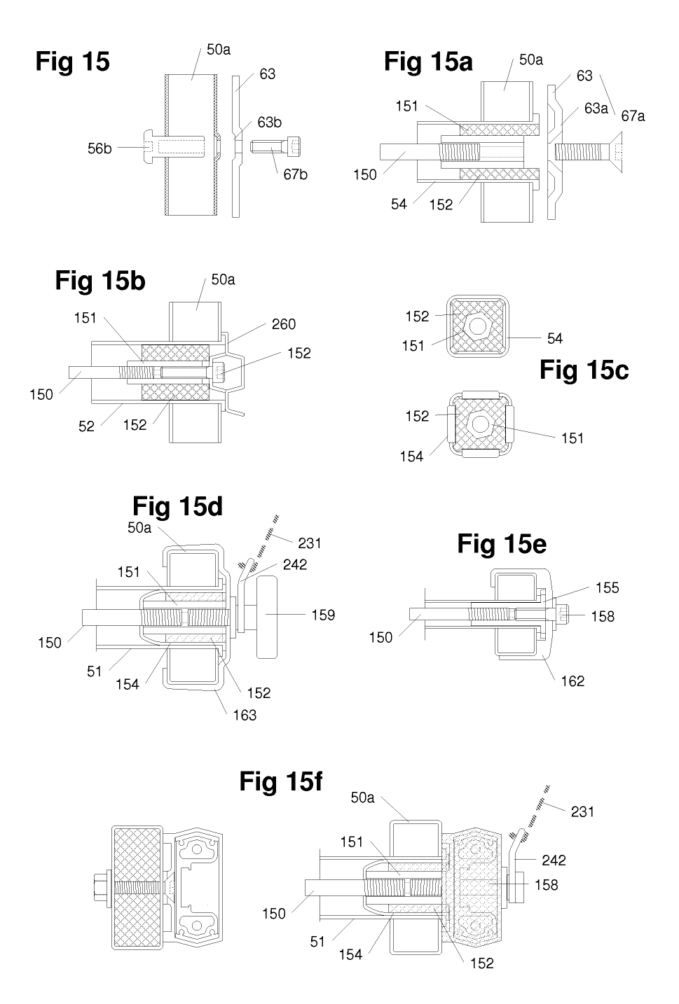

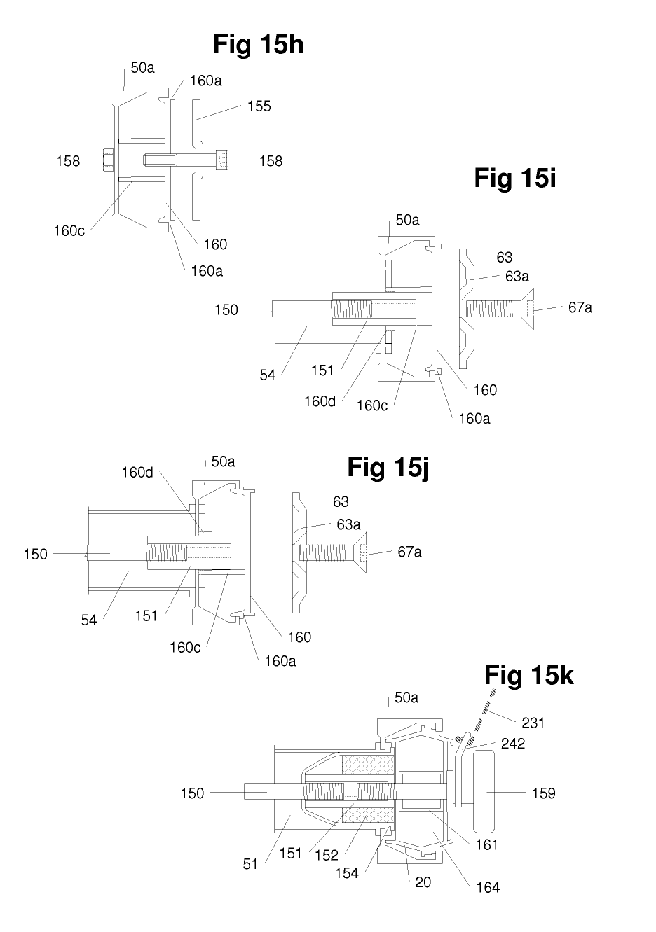

FIGS. 10c and 10d show the load transfer arrangement between the hub unit 61 and the ladder stile 50a. The main plate 63 for the transfer is a pressed and bent metal plate, with various elements. Portion 63a is a pressing to accommodate the ladder rung projection beyond the face of the stile 54a, with a pressing in the reverse direction to accept a countersunk bolt 67a. This portion 63a pressing strengthens the plate between flanges 63c and 64 so that pressure applied though the anchor bolt 54c and 67a does not bend the plate 63. Portion 63b is another pressing to accept a bent portion of the hollow ladder stile to resist rotational forces. The system fixing methods are described below in greater detail with reference to FIGS. 15a to 15c in greater detail. Here the fixing bolt 67a is connected to a bolt through ladder rung 54, and bolt 67b is connected to a receiver 56b through the stile 50a to resist rotational forces. The flange 63c is the hinge 62 support bracket which is bent to be square to the line of 62 around the point of contact between the two elements.

Internal load transfer between the hub unit 61 and the plate 63 is through a combined unit consisting of an injection moulded component 64 and an extruded or machined metal component 65 which is bolted to the plate 63. The plastic material to be used for the load transfer element 64 will be a polycarbonate; it is formed to control the angular rotation of the hub 61 to the three positions 60a, 60b & 60c as shown in FIGS. 10g and 10h which indicates the interface between the hub unit 61 and the load transfer unit 64 which is 61f as shown on FIGS. 10a & 10b.

60c is the position of the stabiliser leg elements when in the closed position. 60a is the position in the fully rotated or standard operating position and 60b is the position in the intermediate position with stabiliser in line with the two ladder stiles. These positions are shown in perspective in FIGS. 7 & 8.

FIGS. 10e & 10f show the compound angular configuration of the hinge angles for the ladder stabilising device. FIG. 10a is the side face of the ladder stile 50a, with the load transfer unit 64 the load bearing interface, 62 is the line of the hinge in that plane. The rearward angular rotation of hinge line from the line of the ladder stile in that plane is A1 and is in the order of 24 degrees. Section (I-I) is square with FIG. 10e but along line of hinge 62, this section is shown in FIG. 10f. The angular rotation of the hinge 62 away from the ladder stile side face but along this plane is A2 and is in the order of 7 degrees.

FIGS. 10g & 10h shows the section (II-II) the interface surface between the hub unit 61 and the load transfer unit 64. The contact surface of 61 is 61f and is shown in the stabiliser's operation positions 60a, 60b & 60c. 60c is the closed position with the leg parallel with the ladder stile. 60a is the main ladder stabilising position rotated outwardly and rearwardly from the ladder when in the usual climbing position. 60b is outwardly from the ladder with the leg in line with ladder stiles and will provide stability when the ladder is in the vertical orientation as with access towers. The angular rotation of the hub unit and therefore the stabiliser leg between the static position 60c and the main operating position 60a is in the order of 160 degrees. The rotation between static 60c and 60b is in the order of 35 degrees.

The angles are all compound so the degrees stated above are approximate as a very slight variation in one angle requires compensating adjustment to the other angles.

The stabiliser tie arrangement between the stabiliser leg and the ladder stile were shown in the open or operating position in FIG. 7 consisting of three basic parts, the connection to the stabiliser leg 20 with unit to be referred to as the stable 220, the rotating link 230, the flexible tie 231 and its connection to the ladder stile 240.

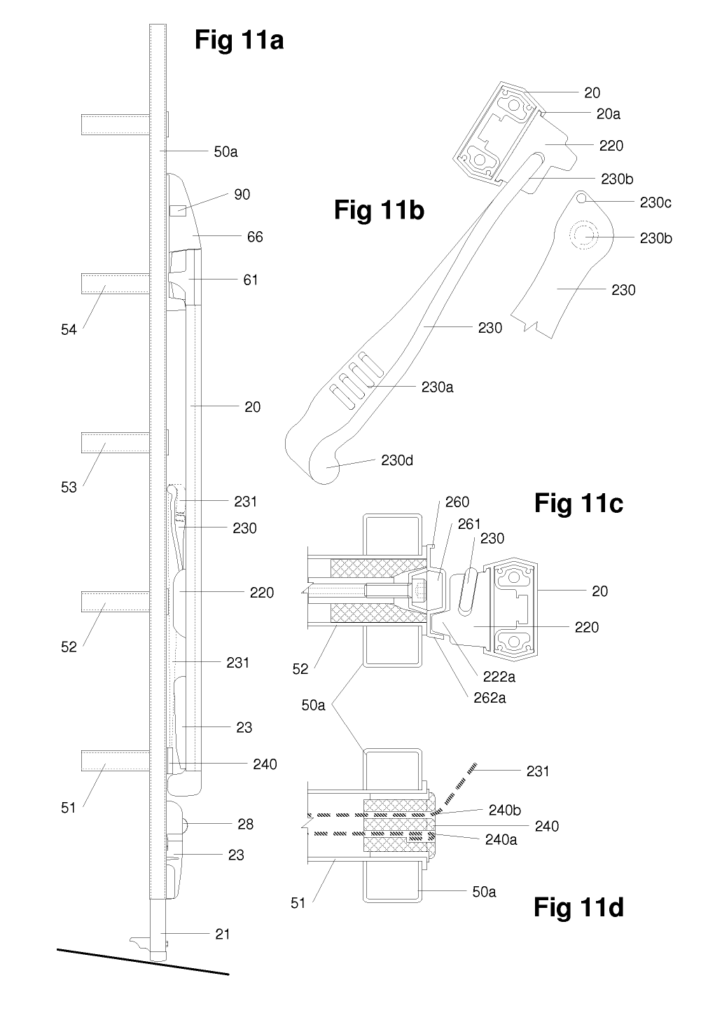

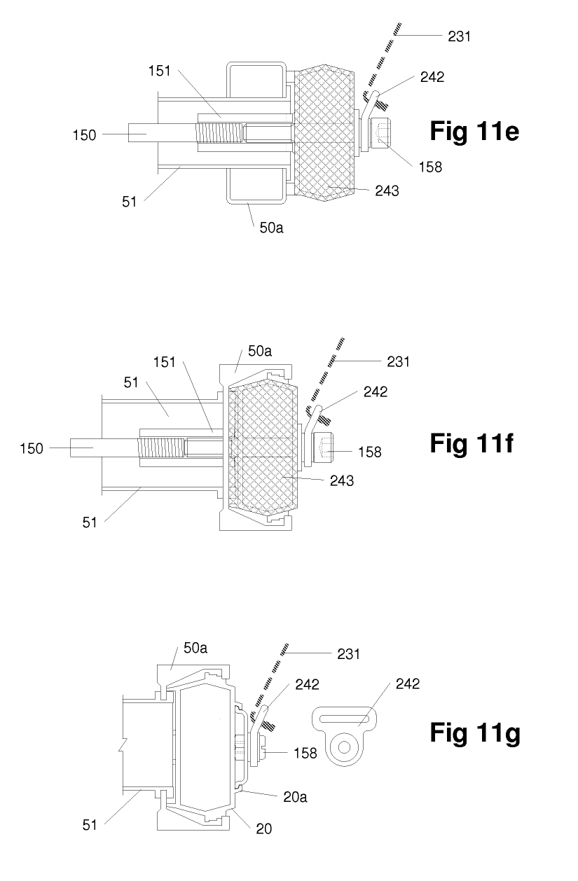

FIG. 11a shows the stabiliser leg in the closed position against ladder 50a. Here stable 220 is close to the end of the second rung 52 with the rotating link 230 projecting upwards in the closed position with the flexible tie 231 jointed at the top close to the curved end of link 230d.

FIG. 11b shows the rotating link 230 in the operating position in relation 220. The link rotates about 230b and has slots 230a through which 231 pass for anchorage of same. The free end of the arm 230 carries a rounded rest 230d over which the strap 231 may fold without kinking during opening, closing or when stowed.

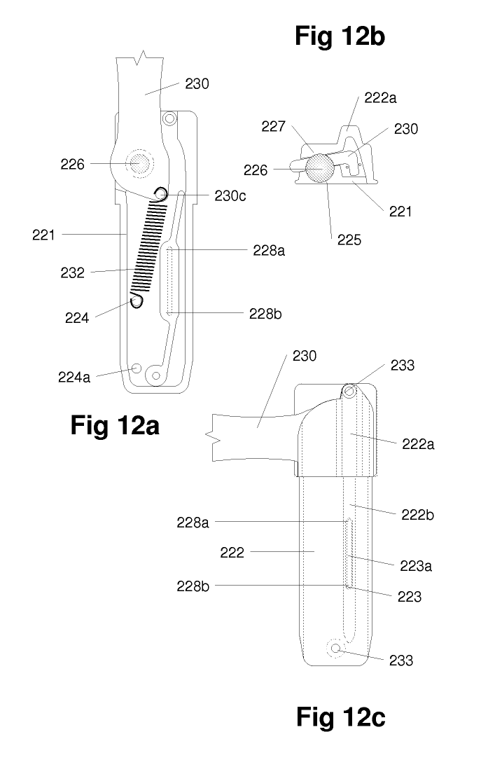

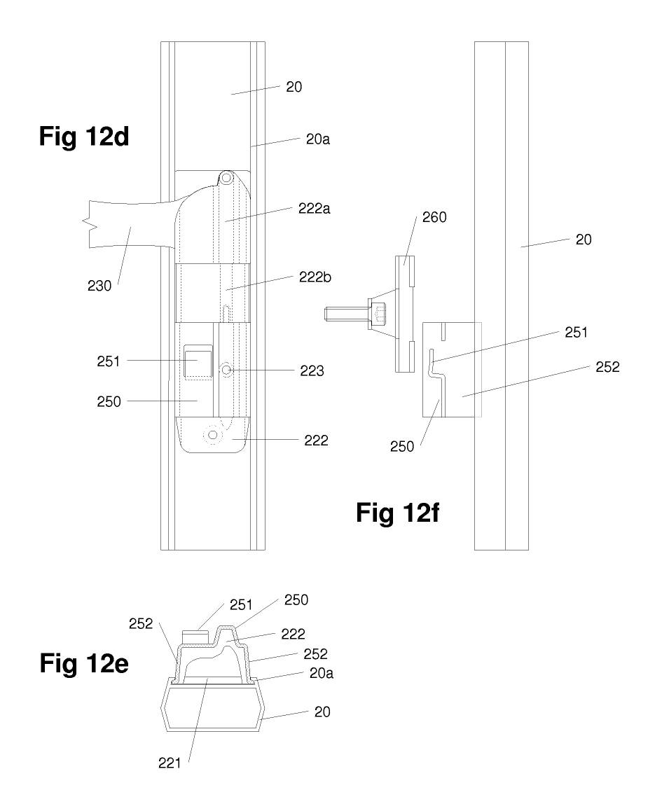

FIG. 11c shows connection of 220 with the ladder in the stowed position with projection 222a fitting into recess 262a in clip 260 which is anchored to ladder rung 52 using internal bolt arrangements. Clip 260 also shown in FIG. 12f forms a slot for connecting leg to ladder stile to prevent transverse movement of leg when stowed.

FIGS. 11d-11g show alternative arrangements for 240 the connection of the flexible tie 231 to the ladder rung 51, being dependant upon the ladder design and the levelling device installed. This is variable so options are shown.

FIG. 11d is hollow ladder with internal levelling device. The plug 240 has two slots 240a, 240b therein for the passage therethrough of stay straps 231. As shown, the lower slot 240a constitutes the anchor point for a stay strap 231 which is folded over and sewn. The stay strap then passes through both plugs 240 to be anchored on the arm 230 associated with the left (as shown) stile of the ladder 50a. The stay strap 231 for the stabiliser on the right (as shown) side of the ladder is anchored to the left side plug, passes through the slot 240b in the plug 240 shown and on to attachment to the arm 230 illustrated in the drawings. Within the rung the two straps twist 180 degrees to each other so that two straps project in the correct orientation with slot 240b either upwards or rearward to the ladder. In this simple embodiment the plugs 240 are free to rotate so as to reduce the development of strap fatigue due to twisting during opening and closing of the stabiliser legs.

FIGS. 11e to 11g show alternative arrangements. FIG. 11e is hollow ladder with add-on leveller. FIG. 11f is ‘C’ section ladder with leveller up to first rung and attached thereto. Where anchorage bolt for the leveller passes through a rung there will be moulded plastic blocks 243 inserted within the extrusion to transmit loads. FIG. 11g is ‘C’ section ladder with longer leveller giving greater adjustability and anchored to ladder between rungs 51 and 52. In this variation the anchorage is to side of outer member of the levelling device using metal clip arrangement. FIG. 17 shows the variations of levelling devices arrangements connected to hollow or ‘C’ section ladder stiles. These variations use a metal or plastic anchor 242 that is free to rotate in the vertical plane around fixing bolt. Flexible tie 231 with folded over and sewn end is anchored by passing through the slot in 242.

The stable 220 consists of housing as shown in FIG. 12a-12c, anchorage clip 250 FIG. 12f relationship between these and stabiliser leg FIGS. 12d & 12e.

FIGS. 12a-12c Stable housing consists of two-part housing 221, 222, adapted for fitment to stabiliser leg 20. The member 221 carries a spacer 223 arranged for maintaining the integrity of the housing, a spring peg 224 and socket 225 for a pivot ball 226. The member 222 carries an opposing socket 227 for the pivot ball 226. Units 221 and 222 can be of different lengths depending upon whether the stable block is to be attached to new or older ladders as retrofits these are secured together with screws 228. The shorter version for new ladder fitment will have section removed between 228a and 228b and spring will use peg 224a

The link member in the form of an arm 230 is mounted to the housing 221, 222 via the pivot ball 226 whereby it can swivel between a stowed and a deployed configuration. The link arm 230 is formed of a mechanically strong plastics material with resistance to ultra-violet (uv) degradation. It has anchorage slots 230a for attachment of a tie strap 231, a hinge recess 230b to receive the pivot ball 226, and a coil spring 232 attachment peg 230c.

FIGS. 12d-12f show the fixing of stable 220 to the stabiliser leg 20. This is achieved by a double acting arrangement that allows vertical adjustment of the position of the various elements especially when installed as an add-on device to existing ladders. For new ladder the length and position of components can be determined beforehand so far less adjustment is necessary.

The metal clip's 250 legs can be pushed together and clipped into or under the extrusion component 20a, this allows vertical adjustment, so that clip 251 aligns with part of rung clip 260 attached to ladder rung 52. Stable 220 will slide between the same elements 20a held by projections formed along the top section of 222. By pushing 220 into 250 the whole is locked together with self tapping screw through to stabiliser leg 20 that only needs to produce slight depression in 20 to limit vertical movement of 220 in relation to 20.

The anchorage of the stabiliser leg 20 in the stowage position is achieved by the small vertical movement of the leg in relation to the ladder to which it is attached. This vertical movement is part of the opening and closing operation as already described. The basic stowage locking clip arrangement of a projection clipping behind a recess can be either way round, i.e. the projection could be on the ladder or stabiliser and ditto the recess. The selected version is dependant on the design of stay 280 which is used for intermediate positioning of the stabiliser leg.

FIGS. 13a & 13b show the stabiliser in the intermediate position 60b as described earlier. To provide stability in this position a stay 280 is provided that has an angled hinge 282 connected to a plate 281 that is slidable within extruded section 20a part of the stabiliser leg 20. The hinge mechanism can have a helical spring 283 included that will when released force the stay 280 back against the leg. Installation of this spring will be dependant upon the achievable resistance against accidental downward movement of the stay when in the operating position connected to the ladder rung 52 via clip 260 which is part of the clip that holds the stabiliser in the stowage position. Connection between 280 and 260 is via a slot 285 or other arrangement forming part of the stay. The stay 280 will be in the same form of construction as the rotating tie link 230. The plate 281 which attaches the assembly to the leg 20 cab be added to part of the stable block 221, this will be ideal for new installation work, retrofit will probably need separation between 281 and 221.

FIG. 13c show an alternative stay arrangement is possible with the stay anchored to the ladder stile with a hinge within or connected to 260. In the stowed position the stay could fold against the ladder stile either upwards or downwards, this would be dependant upon how the helical spring is installed and connect to 251 part of 250.

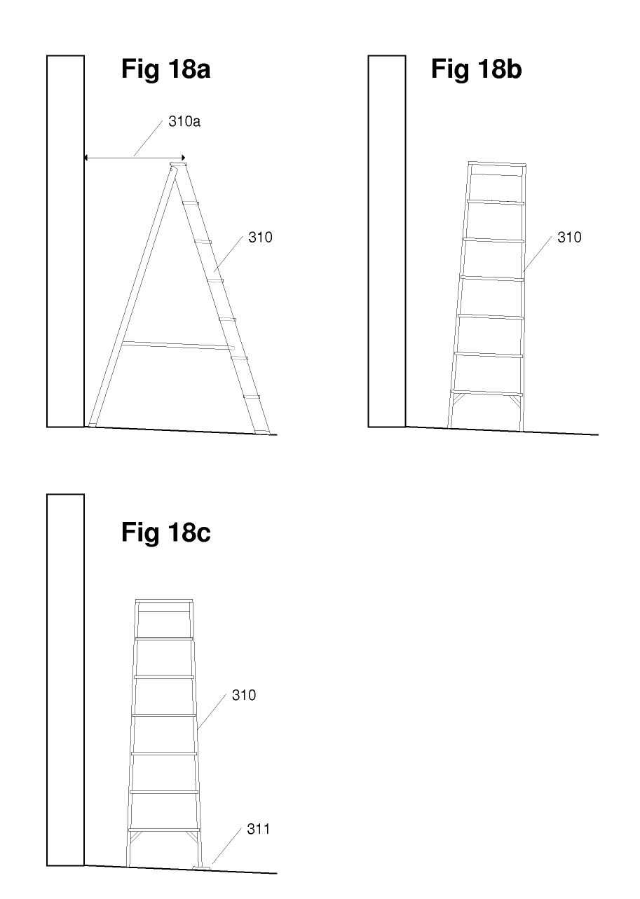

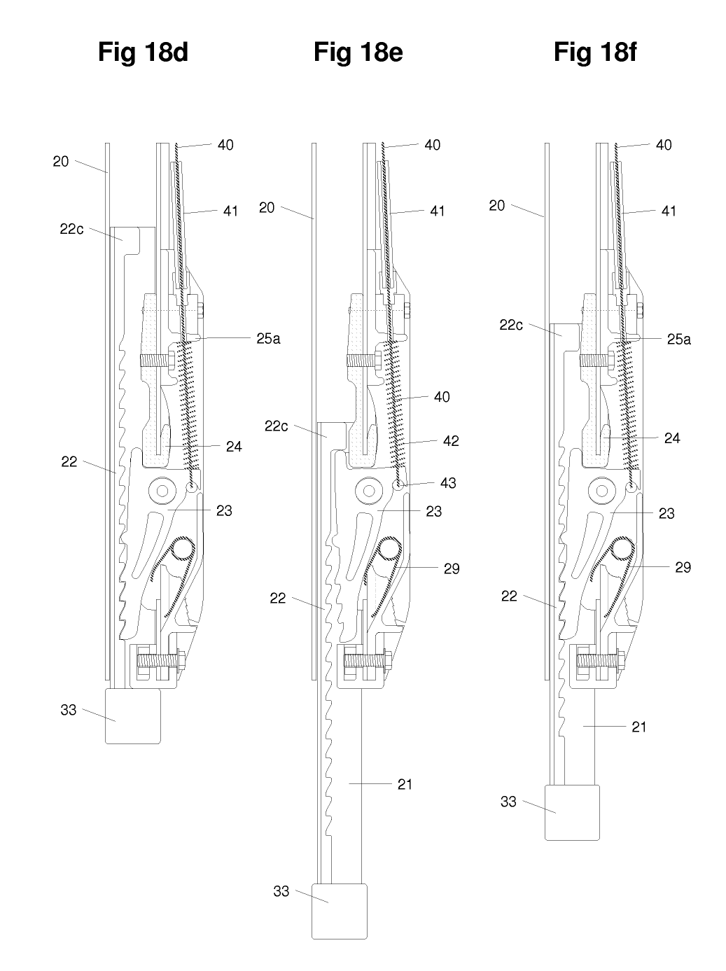

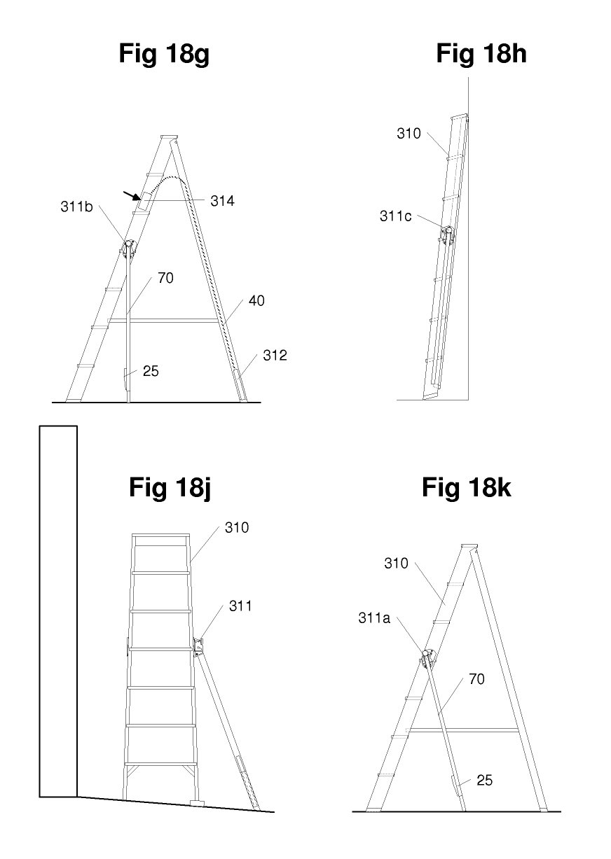

FIG. 14 shows the detachable stabiliser with the leg in one of the open or operating positions 70b attached to ladder stile 50a with a bolt assembly through rung 53. The general operating arrangement of this is shown in FIGS. 8b where it would provide stability for a composite ladder when used in configurations different from a standard extension ladder, 8e for ladders used vertically in access tower, and also when attached to a step ladder FIG. 18. This removable stabiliser uses the same leg construction as the stabiliser as already described.

The hub is shown in greater detail in FIGS. 14a-14f. The stabiliser is simply attached to the appropriate ladder or step ladder via a plate structure that consists of basically of two plates or of a machined single plate or of a cast metal or high strength plastic component. A section of the two plate version is shown in FIG. 14e. This is attached to ladder type structure along the same lines as the main stabiliser system anchorage plate 63 as already described.

The plate can be to various designs depending upon the operation slope requirement of the device as this varies upon the type of ladder or access equipment to which it is being attached. The essential element it that it is thin so wherever it is fixed it does not hinder or adversely affect the performance of that equipment when the stabiliser is not being used or is not attached. FIG. 14 shows the plate fixed to rung 53 of the middle extension ladder component 50b of a composite ladder assembly where the stabiliser leg will be required in certain arrangements of that system, but not in others. With a composite ladder there is an arrangement when the top section actually touches the ground so an additional pair of plates may be required attached to rung 53 of the top section of ladder 50c.

FIG. 14a shows the shape of stile plate 73 when attached to a composite type ladder or that being used for access tower. It is attached to the stile with countersunk bolt 77a to rung 53 and to resist rotation forces 77b. A vertical section through the plate is shown on FIG. 14f. The rebated circular shaped load transfer element 73a links with machined recess 74a on the hinge unit 74. A ‘L’ shaped slot takes a projecting pin 74b. When the stabiliser assembly is fixed to the stile the pin 74b is set into the ‘L’ section of 73b so that both faces of 73 and 74 will touch. 73 can then be pushed upwards and 74a will link around 73a. In this position the hinge unit 74 will rotate around its centre of rotation and pin 74b will move around the curved section of 73b. When the hinge unit is parallel to line of stile the fixing bolt 75 can be turned using knob into threaded hole 76a. Onward rotation allows the stabiliser's leg angle to be altered to an angle with the line of the stile, by bolting into 76b. Each stile will require handed versions of the plate.

FIG. 14b shows a revised version for attachment to wide stiles of a step ladder. Here there are three positions for the bolt 75 that will position the leg 20 parallel in 76a, vertical in 76b and at a rearward angle in 76c. The hinge member 74 is shown in the rearward angle position.

FIGS. 14d & 14e show both surfaces of the cast metal or moulded plastic hinge member 74. 74a is a machined recess though if made of polycarbonate the moulding would be formed. This recess clicks round 73a on the plate 73 and will transfer stabilising forces between the same.

FIGS. 14f & 14g show the vertical section through the assembly, including the hub unit link with the leg 20 with a mounded plastic hub component part 71a into the stabiliser leg and 71b the visible part with bearing bolt 71c that allows rotation of leg in the vertical plane from the stowage position parallel with stile to various stabiliser angles. The simple fixing of angle would be a removable pin passing though both 74w and 71b though a catch arrangement could be included with 71b with pins passing outwards through 74w. When the widest angle is reached the load bearing forces will be greatest and these can be transferred via 71e in contact with 74e. The distance of leg 20 away from the ladder stile 50b in the stowage parallel position is variable depending upon operating requirements. The sizes of the cross wall elements 74x are again variable depending upon use of the stabiliser and the sideways forces generated by the angles of the leg in relation to the ground and to possible movement of the ladder or access equipment.

FIGS. 15's demonstrate the mechanical fixing of stabilising components to a wide range of ladders and sundry type of equipment. The most effective arrangement for the transmission of loads to the access equipment is through or just below the rungs or steps. That way the stabilising equipment share the forces, with the ladder or steps being held tightly between the same.

FIG. 15 depicts fixing arrangement to hollow stile aluminium ladder 50a with thin skin, where the skin is deformed into a recess 63b within the device being attached. The deformation achieved by tightening internally threaded component 56b to bolt 67b passing through the device being fixed. The deformation being tight with the recess is able to transmit sideways or rotational forces.

FIG. 15a illustrate the main method of fixing the stabiliser hub plate 63 to a hollow ladder and is section through ladder rung 54 and a hollow stile 50a. The plate is deformed so that the end of the rung projecting beyond the stile is contained with a recess 63a that is deformed again in the opposite direction to accept countersunk bolt 67a. Load to the ladder is taken by long threaded bolt 150 through rung with long hexagonal internally threaded nut 151 connecting the long bolt to the countersunk bolts at each end. A load bearing plastic block 152 inserted into end of rung transmits forces laterally in all directions to the rung and ladder stile.

FIG. 15b shows section of the plastic block 152 in relationship to the rung 54 and hexagon nut 151. There are recesses parallel with each face that will allow metal clip 154 to be inserted between the plastic block and the rung. This clip arrangement is further detailed in FIGS. 15m & 15n.

FIG. 15c shows connection between ladder and anchorage point for clip 260 or other similar device where lateral forces are lower than in FIG. 15b. The bolt 150 will be of smaller diameter and the hexagon nut and matching perforation in plastic block will match.

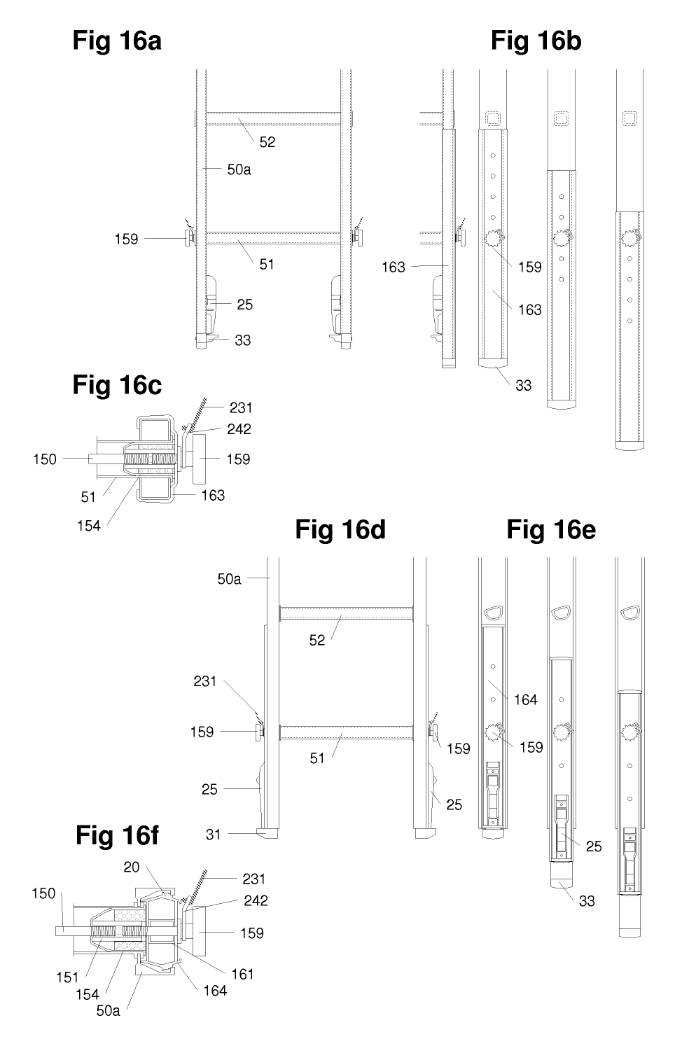

FIGS. 15d show anchorage of levelling device extension whereby stile is extended by incremental amounts but the ratchet extending means is restricted from operation. See FIG. 16a for proposed arrangement.

FIG. 15e shows the way to anchor to small section step ladder legs with low level tubular member between legs with a through bolt 150 and internally threaded flanged member 155 with sides of flange cut away to allow tightening with spanner. An extruded aluminium component 162 can then be slid over the bottom of leg to extend or alter the contact with the ground. Holes at predetermined points along 162 will allow anchorage of same with bolt 158. The shape of the extrusion will depend upon the task to be accomplished and the loads and bending forces that need to be accommodated by the extension or device.

FIGS. 15f shows the anchorage of levelling device as an add-on device for retrofit to an existing ladder. Here without sufficient strength within stile it may be necessary to provide additional anchorage with bolt through the existing ladder foot member. The advantage of this arrangement is that with one basic size of levelling device it can be fitted to a wide range of ladder types and sizes, from hollow stiles through to solid timber stiles and glass fibre stiles of other shapes and cross sections.

FIG. 15g shows the arrangement for transmitting sideways or rotational forces of the stabiliser plate to an extruded ‘C’ section ladder stile. An extruded aluminium section 160 made especially for each ladder stile section that will click between the flanges of the stile with sideways projections to take the width of the plate member and deeper projections 160c back to the main flange, through which bolt up forces are transmitted. Deformation of the section into 63b will not be required.

FIG. 15h shows main anchorage of the stabiliser plate member to the same type of ladder stile. The same extrusion is employed, but there has to be a cut out 160d in the rearward projections 160c towards the main flange to accommodate the rung ends. With this arrangement there is no possibility of sliding, so hence the push in clipping action. The width between rearward projections 160c set to hold the hexagon nut so allowing tightening of anchor bolt 67a

FIG. 15j ditto but shows smaller section ladder stile and another extrusion

FIG. 15k shows fixing of levelling device to ‘C’ section ladder stile.

FIG. 16a shows a ladder with levelling devices installed within the hollow stile. The pawl being inward facing then allows additional variation in height between the adjusted feet, as shown in 16b.

FIG. 16b In order to provide extra levelling potential for a ladder with hollow stiles it is necessary to provide additional strength to the stile at its intersection with the lowest rung. Here this is achieved by passing an extruded section 163 with a foot attached up the stile to above the first rung. The unit would have a series of holes for anchoring to rung fixing component as described elsewhere. This would allow different level variations to be achieved with only a simple arrangement. Should additional vertical variation be required by the user all that would need to be supplied would be longer versions of 163 which could be cut down to the desired length.

It would also be possible with longer versions of 163 to have a levelling device attached to the base, giving the user extra adjustment capability.

FIG. 16c shows cross section of FIG. 16b arrangement.

FIG. 16d shows a ‘C’ section ladder with levelling device fitted within the stile recess. While the adjustment capability if the device is limited to around 100 mm as the inner telescopic member needs to be restricted in height to allow fixing the the first rung. The supporting extrusion 164 can extend up further almost to the second rung, this then allows the whole unit to be fitted at various vertical setting as shown in FIG. 16e.

FIG. 16e shows the levelling device positioned at various positions in respect to the height of the other foot. Should the user require extra height variation longer adjusters could be supplied that could be cut to the required length.

This adjustability would allow the ladder to be used very effectively as part of an access tower where great variations in ground level could be accommodated.

FIG. 16f shows cross section of FIG. 16e arrangement.

Wear and Friction Problems

Internally sliding aluminium extrusions can suffer problems with friction and wear where the components touch. The traditional solution has been to have the extrusion's surfaces hardened by anodising. This arrangement will work over a limited period, but in time there are problems with wear etc. Oil or grease will help, but as aluminium is a relative soft metal there still can be problems especially when sand or abrasive material is involved. General ladder use involves these sorts of materials so stabilising and levelling devices will suffer unless an effective solution is found.

PTFE would be an ideal material, but adhesion to the extruded components would be difficult and very expensive to achieve. Nylon becomes the next choice as it can be extruded into sections and these could be slipped or pushed into recesses in aluminium extrusions. This will be the first natural step for the stabiliser and levelling devices.

FIG. 17a is a section of a rectangular metal extrusion 21 formed with grooves 21b at each corner. Nylon friction reducing strips 21c fit into the grooves 21b. The strips 21b are arranged to be compressed when fitted into the grooves so that they are therein retained.

FIGS. 17b-17d show possible variations to a section of a metal extrusion 21 in the form of a stabiliser's or levelling device's extension leg. This comprises also a rack carrying central portion 22 and, either side thereof, two lobes 21d.

FIG. 17e shows a possible variation where no plastic material is installed to the component.

The slide bearing design options will depend upon the stage of development in the whole stabiliser and safety system. As volume production goes up cheaper unit manufacturing processes can be installed for the manufacture of same. These processes could involve considerable capital costs though there could be substancial savings in overall coats.

Step ladders are basically fairly stable in use as there should be four feet on the ground. Internally with level floors there should be no problem at all, but still accidents occur. It is usually when work is being carried out from the steps, and sideward pressure is exerted. Reasonably constructed step ladders will resist considerable sideways pressure and will remain static, but the problems occur when due to some unevenness in the floor or ground the ladder suffers a wobble, not all four feet are on the ground. The steps rock between two of the four feet. This can actually happen when the ladder won't deflect slightly to accommodate the roughness or unevenness.

FIG. 18a shows the recommended way of working from a step ladder, over the top with equipment square to wall. This is ok when there are only about five steps and user is standing on the second or third steps. Above this it is almost impossible to reach the wall and certainly very difficult to work. Arms are just not long enough to reach over the 310a

FIG. 18b illustrates how a user will get over the problem, the steps will be turned to be parallel to the wall etc. Outside almost always the ground will slope slightly away from the wall, this will make the ladder tilt, which makes the ladder feel and look unsafe. The solution, pack up the steps 311 so it is vertical or tilts slightly towards the wall. Standing on bottom step it will feel fine, as it won't rock even though all legs are not properly seated. Only when up the steps a little way does rocking begin.

FIG. 18d-18f shows section through the levelling device that will easily remove the tendency to rock or wobble. Similar to levelling devise as shown in FIG. 1 except the pawl 23 is of a different shape, without an operating handle being controlled by a cable 40 connected to 43. The compression spring 40 is not essential but keeps cable tight. The pawl is pushed against the ratchet by the helical spring 29.

FIG. 18d shows the foot 33 fully retracted. FIG. 18e the cable 40 is pulled, that retracts the pawl from the ratchet and under gravity the foot will drop and will if there is nothing to stop the foot from falling it will stop as shown with 22c stopping against 26e. If there is ground beneath the foot will stop when the two meet as shown in FIG. 18f. Release the cable and the pawl will relock the device. If there had been upward pressure on the foot when the cable had been pulled the foot and inner member 21 would have been forced upward until there was no more upward pressure on the foot. Cable released pawl would again lock device in position.

The cable 40 will be connected to a push button device 314 that will contain a rocking element which will transform the downward pressure on a button to a pull pressure on the cable 40. The button device will be installed somewhere on the step ladder so that the user can press the button every time the ladder is moved and repositioned, before using the equipment.

FIG. 18g shows possible position of button device 314 attached to side of step ladder, with a cable 313 going down to the levelling device 312. A cycle brake cable would allow bending of same when the step ladder is closed for storage.

The stepladder bolt-on stabiliser is shown in three possible positions in FIGS. 18g-18k. Two operating positions either vertically as FIG. 18g or at an angle to vertical are possible together with storage along the stile. Generally only one stabiliser will be required as it is simply bolted to either side of the step ladder. When not required it can be simply removed and used with other equipment such as ladder access tower.

Jointing System for Hollow and other section Ladder Stiles

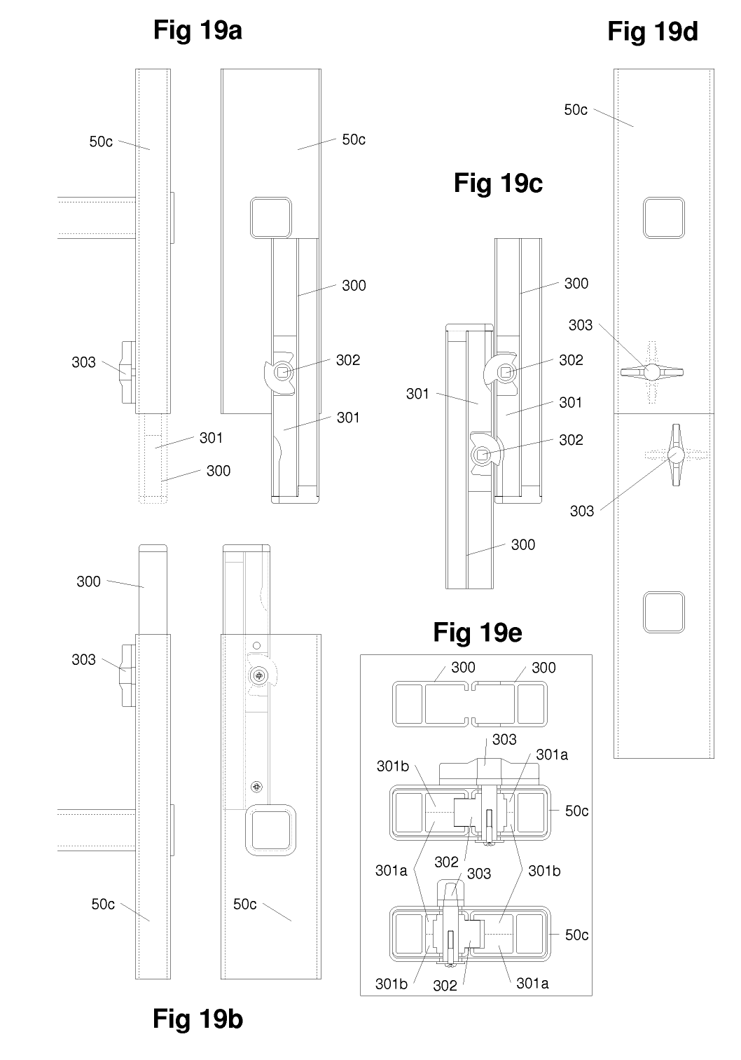

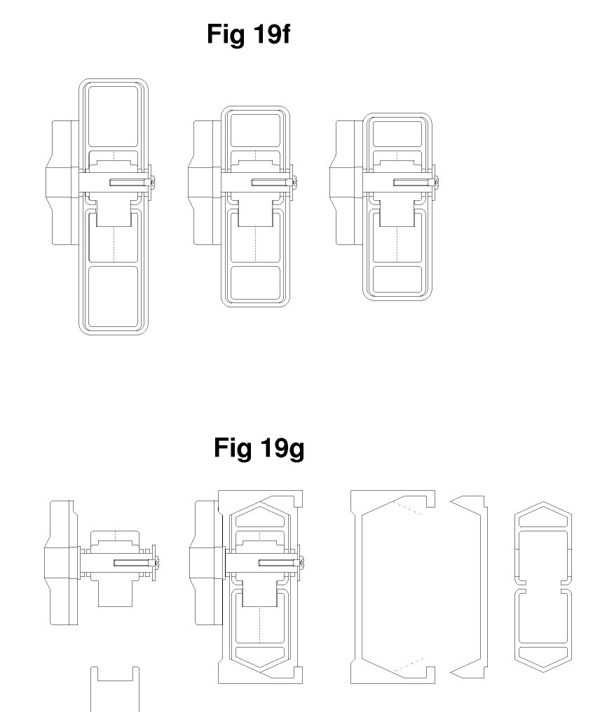

FIGS. 19a-19d shows details of simple arrangement for joining together two stile sections of a hollow type ladder similar to surveyor's ladders that can be broken down into a number of short sections. It allows better load transfer between the sections so that in use the ladders will be more resistant to bending and be easier to put together and to take apart. In this example the connecting element is constructed in two identical components with each being fitted to the end of the stile sections being assembled.

The man part being an aluminium extruded section 300 forming a ‘U’ section with an integral hollow section. To cover different size ladders the ‘U’ section remains the same size across the board. Within the ‘U’ section is inserted an injection moulded component 301 consisting of a pair of handed parts 301a & 301b. This forms the bearing recess for a pair of similar material rotating cams 302. The cam arrangement is such that they face opposite directions along the line of the stiles

FIG. 19e shows sections through the stiles when the projecting components are fully inserted/

FIG. 19f show how different sizes stiles can be accommodated using the same moulded components.

FIG. 19g shows that the same basic assembly can be used to link together ‘C’ section ladder stiles.

This same device can then be fitted to allow the top section of a composite ladder to be split into two sections allowing the top section to be used in the horizontal direction as parts of ladder access towers.

It will also allow composites to add different platforms to the top sections of same.

Slope Indicator

The rocker 92 has a u-shaped section and thus holds the roller 94 nestling thereinside. The rocker 92 has an upper arm which is slotted to engage a pin 106 attached to a counterbalanced indicator bearer 107. The indicator bearer 107 carries the indicator bands 96, 97 and 98 and is arranged to rotate around a central axis 108.

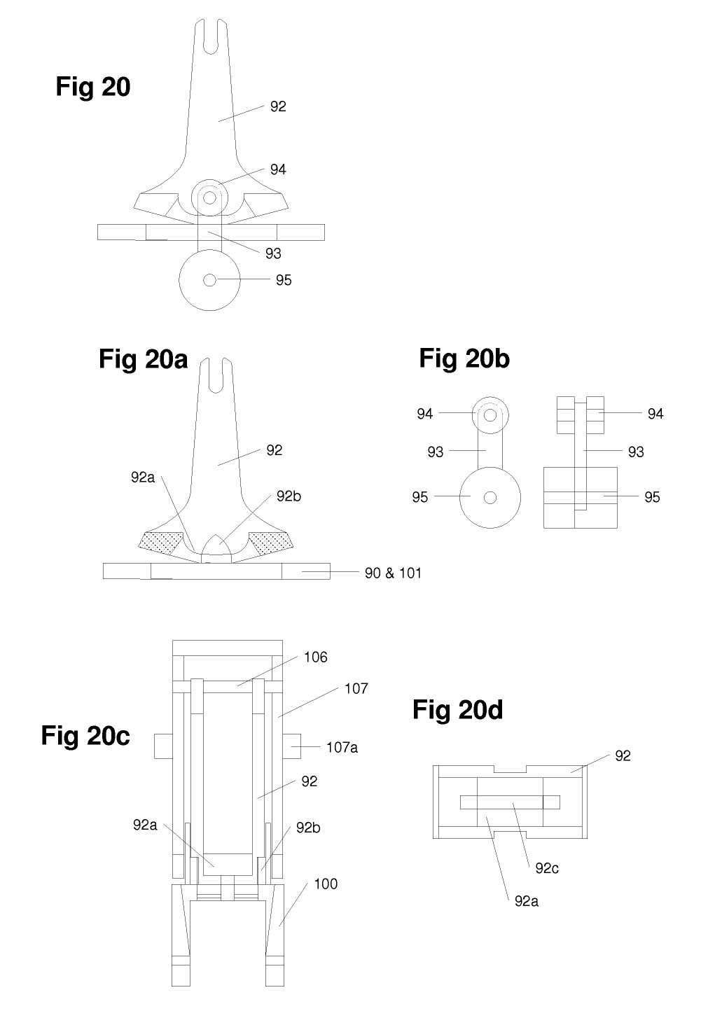

FIGS. 20 to 22 illustrate a safe ladder angle indicator device for indicating whether or not a ladder is at a safe angle. The device comprises a datum plate 90 associated with a ladder stile 20 and, there alongside, a datum plate 101 associated with a ladder stabiliser (not shown). Upon the plates 90, 101 at a junction thereof, is a rocker 92 shaped to flip between one of three configurations on the plates 90, 101. The rocker 92 is recessed at the centre thereof and constrained to the plates 90, 101 by a yoke 93. The yoke 93 has a roller 94 arranged for rolling in the recess in the rocker 92 and a weighted roller 95 beneath the plates 90, 101.

The rocker 92 is associated with an indicator arranged to provide an “unsafe (too steep)” 96, a “safe” 97 and an “unsafe (too flat)” 98 indication, as seen through a viewing window 99.

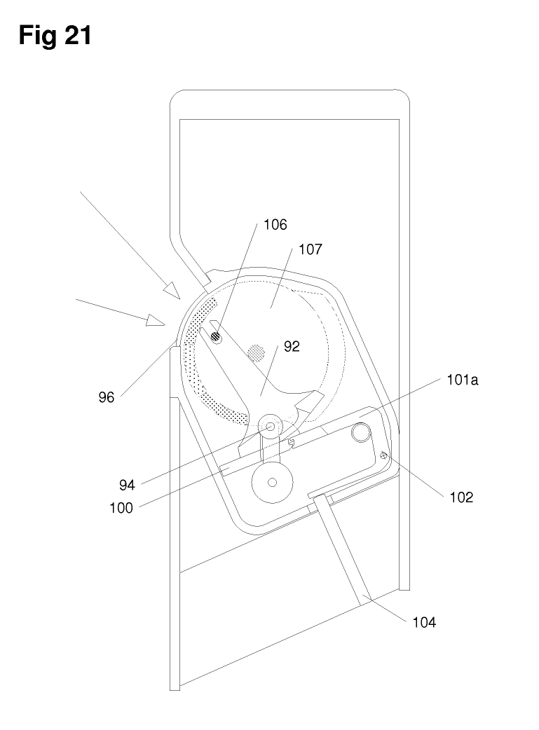

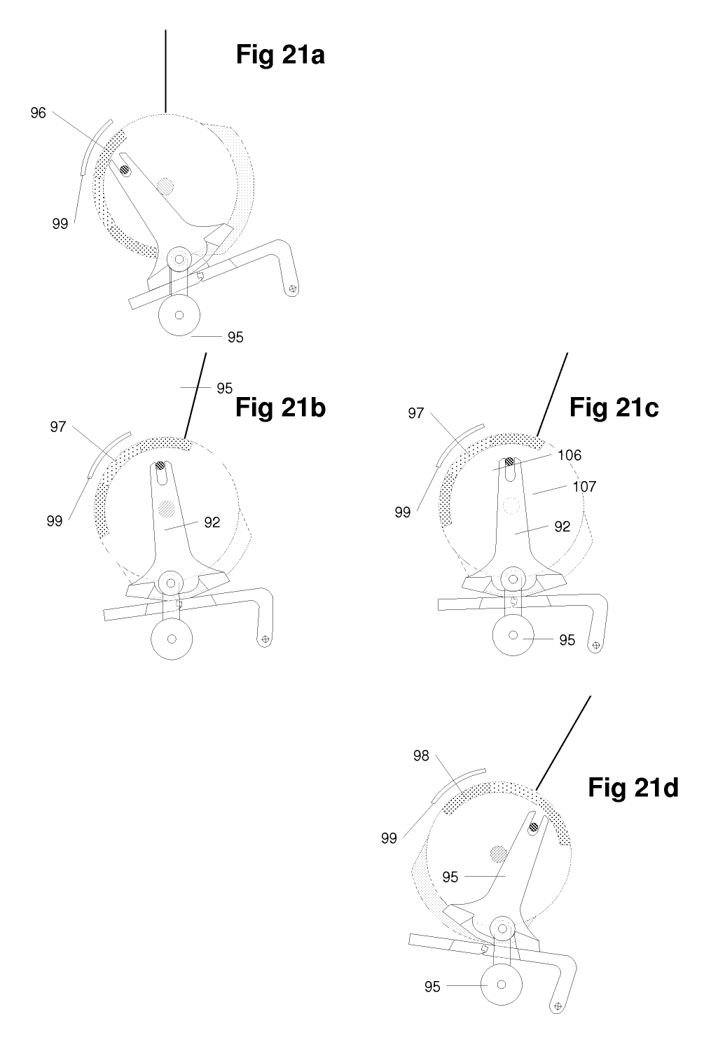

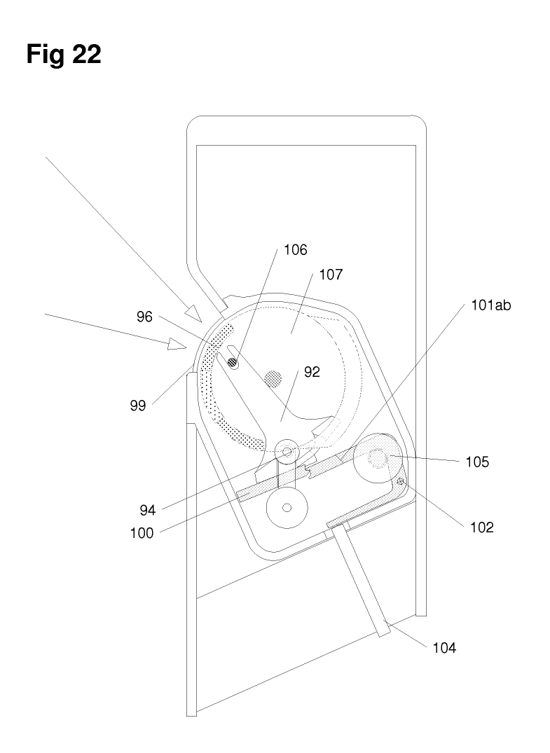

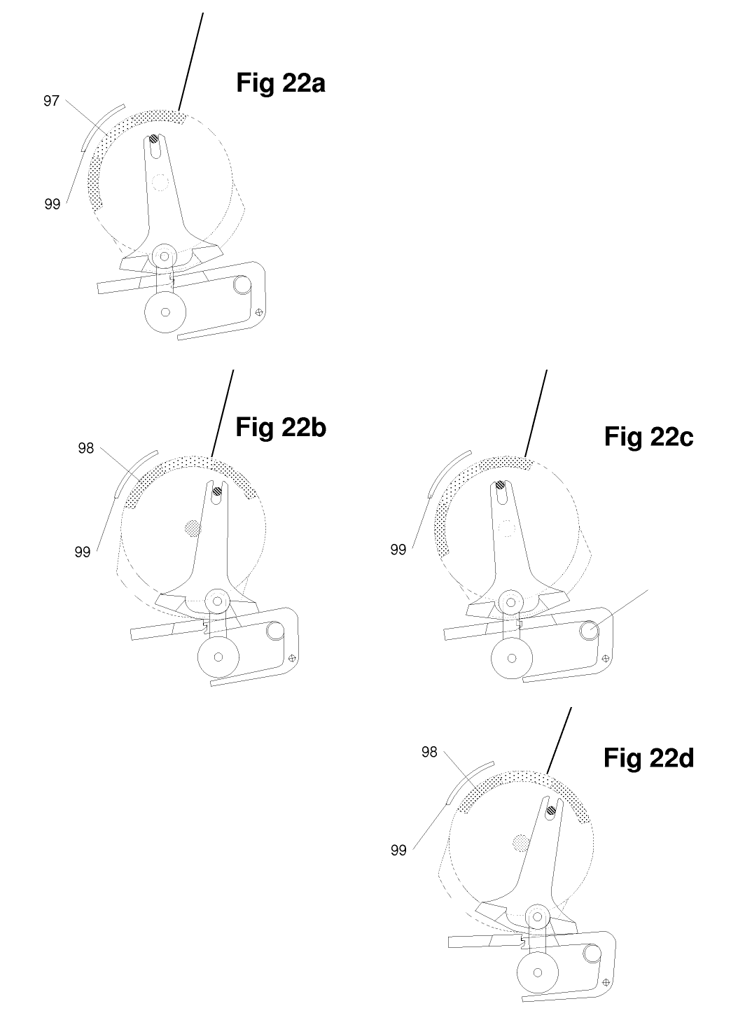

FIGS. 21b and 22c, ladder with deployed stabiliser and at slope 1 in 4 and 1 in 3 respectively, and FIGS. 22a and 22c, unstabilised ladder at 1 in 4, represent the configuration when the slope of the ladder is such that it is safe to use. The roller 94 is centrally located and not impinging upon an end of the recess. The rocker 92 is untipped and a “safe” indication is adjacent the viewing aperture 99. FIGS. 21 and 21a, stabiliser deployed, and 22, unstabilised, represents the configuration when the ladder is too steep. The roller 94 has rolled to the left end of the rocker recess thereby causing the rocker 92 to flip to the left and an “unsafe” indication is adjacent the viewing aperture 100. FIGS. 21d, ladder with stabiliser deployed, and 22 and 22d, ladder unstabilised, represents the situation when a ladder has been erected “too flat”. The plate 101 associated with the stabiliser is dropped relative to the plate 90 and the rocker 92 has the more readily flipped to the right and an “unsafe” indication is provided at the viewing aperture 99.

Typically, for a ladder without stabilisers deployed, the safe range of angles for ladder erection is from 71° to 76°. When stabilisers are deployed, the range may be extended to from 60° to 76°. Typically also, the indicator is arranged to show “red” when the angle of erection is such that the ladder is unsafe, and “green” when it is safe.

Detail of the level indicator, as fitted in the hinge between a ladder stile 20 and a stabiliser 40, is shown in FIGS. 20 to 20c, together with FIGS. 21 and 22. The plate 101 pivots around a pin 102 and is attached to an operating arm 103. A lever 104 is arranged for operation by the stowage/deployment of the stabiliser 40. A spring loaded button 105 enables freeing of the plate 101 for checking or resetting, particularly after the ladder has been moved.

The invention can accordingly be seen as comprising four main elements, namely:

A. An expandable or telescopic load bearing device as per item 1 above that also forms the major element of item 5 above;

B. Stabiliser hub and leg arrangements;

C. Fixing system of add-on components to ladders using hollow rungs;

D. Jointing system for hollow and other section ladder stiles.

For the expandable or telescopic load bearing device (Element A) the main improvements are:

I. The Load Transfer capability without using the ratchet spindle to transfer loads.

II. The ratchet being made of plastic of a width compatible to the load being transferred, because of I. above totally changes the ratchet design capabilities.

III. The capability of releasing the ratchet so that the inner component can move in or out under the forces of gravity (Stepladder Anti-wobble)

IV. The ratchet arm arrangement is revised now coming out through the outer tube as single component set in a plastic housing unit. etc, etc.

For the stabiliser hub and leg arrangements (Element B) the main improvements are:

I. Push down and rotate to auto lock in the three possible positions—stored, in line with ladder stiles and ladder stabilising position.

II. Compound angles of hinge pin to face of stile

III. Altered anchorage system.

Fixing system of add-on components to ladders using hollow rungs (Element C):

I. Basically a system utilising a end threaded bolt held in ladder rung with long hex. nut with clips and or plastic inserts. FIGS. 15 & 16

1-119. (canceled)

120. A device, the device comprising an expandable load bearing device, and the device further comprising:
an outer member;
an inner member movable within the outer member; and
ratchet apparatus having a pawl attachable to the outer member and a rack attachable to the inner member, the outer member having a load transfer member, the pawl being movable into and out of engagement with the rack to prevent movement of the inner member with respect to the outer member, and the pawl having a shoulder arranged to bear upon the load transfer member when the pawl is in engagement with the rack.

121. A device as claimed in claim 120 and having spring apparatus to urge the pawl into engagement with the rack.

122. A device as claimed in claim 120 and wherein the pawl has a plurality of pawl teeth and the rack has a plurality of rack teeth.

123. A device as claimed in claim 122 and wherein the rack teeth and pawl teeth are rebated to assist in retaining engagement therebetween.

124. A device as claimed in claim 120 and having a shield fitted to the outer member to inhibit accidental disengagement of the ratchet apparatus.

125. A device as claimed in claim 120 and having a locking device for inhibiting accidental disengagement of the ratchet apparatus.

126. A device as claimed in claim 120 and wherein the rack has rack teeth and the pawl carries a low friction cushion arranged to ride the teeth of the rack.

127. A device as claimed in claim 120 and wherein the outer member has an edge formed thereon and the load transfer member is recessed to engage around the edge.

128. A device as claimed in claim 120 and wherein any one, two, three, or four of the pawl, the rack, the shoulder and the load transfer member are formed of aluminium alloy or a plastics material.

129. A device as claimed in claim 120 and wherein the pawl incorporates a pawl carrier, the pawl carrier carrying pivoted thereto a control arm and pawl spring apparatus urging the pawl into engagement with the rack.

130. A device as claimed in claim 129 and wherein the pawl carrier is shaped to enable fitment through a side of a ladder stile of a ladder, the pawl carrier comprising also a wedge attachable thereto to configure the pawl carrier with respect to the ladder.

131. The device of claim 120 wherein the device further comprises one of ladder, table leg, and access tower.

132. The device of claim 120 wherein the device further comprises a ladder and the outer member comprises a stabiliser arm.

133. A device as claimed in claim 132 and wherein the ladder has two stiles and a stabiliser leg is hingedly attached to each stile in such a manner so that each stabilizer leg is deployable to swing from a stowed configuration adjacent a stile to a deployed configuration both outward and rearward of the stile;
locking means for locking the stabiliser legs in both deployed and stowed configurations; and
stay means between each stile and a corresponding stabiliser leg which stay means automatically deploys and stows with the stabiliser legs.

134. A device as claimed in claim 133 and wherein each stabilizer leg has a stay base and the stay means comprises a link member and a stay strap, the link member hingedly attached to a stay base on a stabiliser leg, each stay strap being attached to the a corresponding link member and anchored to the ladder.

135. A device as claimed in claim 134 and wherein the stay base incorporates spring apparatus to bias the link member towards a stowed configuration.

136. A ladder as claimed in claim 135 and wherein the ladder has a rung pitch and the link member has a link length, the strap member has a strap length, and the length of the link member is such that strap length equals one rung pitch plus link member length, and strap length plus link length is a stay length for when the stabiliser is fully deployed, whereby the strap member is under tension when the stabiliser is stowed.

137. A device, the device comprising an expandable load bearing device, the device for attachment to a thing, the thing being one of ladder, table leg, and access tower, and the device further comprising:
an outer member;
an inner member movable within the outer member; and
ratchet apparatus having a pawl attachable to the outer member and a rack attachable to the inner member, the outer member having a load transfer member, the pawl being movable into and out of engagement with the rack to prevent movement of the inner member with respect to the outer member, and the pawl having a shoulder arranged to bear upon the load transfer member when the pawl is in engagement with the rack;
spring apparatus to urge the pawl into engagement with the rack;
the pawl having a plurality of pawl teeth and the rack having a plurality of rack teeth; and
the rack teeth and pawl teeth rebated to assist in retaining engagement therebetween.

138. A method of fitting to a ladder a device, the ladder having a ladder stile, the ladder having at least a first rung and a second rung, the device comprising an expandable load bearing device, and the device further comprising an outer member, an inner member movable within the outer member, and ratchet apparatus having a pawl attachable to the outer member and a rack attachable to the inner member, the outer member having a load transfer member, the pawl being movable into and out of engagement with the rack to prevent movement of the inner member with respect to the outer member, and the pawl having a shoulder arranged to bear upon the load transfer member when the pawl is in engagement with the rack, an extension leg carrying the rack, the pawl carrier carrying pivoted thereto an operating arm and spring apparatus urging the pawl into engagement with the rack, the pawl having also a shoulder arranged to abut the load transfer member when the pawl and the ratchet rack are in engagement and the method comprising the steps of:
forming a rectangular aperture in a ladder stile below the second rung;
sliding the extension leg carrying the rack within the ladder stile; and
fitting through the rectangular aperture first the shoulder and then the pawl carrier.

139. The method of claim 138 further comprising urging the pawl into engagement with the rack.
